(19) United States
(12) Patent Application Publication
(10) Pub. No.: US 2023/0377023 A1
(43) Pub. Date: Nov. 23, 2023

(54) SYSTEMS AND METHODS FOR USER PERSONALIZATION AND RECOMMENDATIONS

(71) Applicant: NBTV Channels, LLC, New York, NY (US)

(72) Inventors: Michael Leon Buzzell, Brooklyn, NY (US); Nicholas Theodore Buzzell, Brooklyn, NY (US)

(21) Appl. No.: 18/358,778

(22) Filed: Jul. 25, 2023

Related U.S. Application Data
(63) Continuation-in-part of application No. 17/936,548, filed on Sep. 29, 2022.
Application No. 17/936,548 is a continuation of application No. 16/908,166, filed on Jun. 22, 2020, now Pat. No. 11,494,824.
(60) Provisional application No. 62/865,005, filed on Jun. 21, 2019.

(51) Int. Cl. G06Q 30/0601; G09G 3/34

(52) U.S. Cl. CPC G06Q 30/0631; G06Q 30/0641; G09G 3/3413; G06Q 30/0633; G09G 2320/062

(57) ABSTRACT

Systems and methods for user personalization and recommendation schemes that are matched to a user profile and provide a highly personalized, interactive experience for the user on an entertainment platform are disclosed. In one aspect of the invention, the highly personalized and interactive experience is facilitated through information from the user profile comprised of user-inputted information, historical data, and outputs from machine learning engines. In another aspect of the invention, the system is capable of outputting the highly-personalized and interactive recommendations onto a viewing screen while media content is continuously streaming on the same viewing screen.

### CROSS-REFERENCE TO RELATED APPLICATIONS

The present application is a continuation in part (CIP) of U.S. patent application Ser. No. 17/936,548, filed Sep. 29, 2022, which is a continuation of U.S. patent application Ser. No. 16/908,166 filed Jun. 22, 2020, now U.S. Pat. No. 11,494,824, issued Nov. 8, 2022, which claims priority to U.S. provisional application Ser. No. 62/865,005, filed Jun. 21, 2019, each of which is hereby incorporated by reference herein.

### TECHNICAL FIELD OF THE DISCLOSED EMBODIMENTS

The present invention relates generally to systems and methods for user personalization and recommendation schemes that are matched to a user profile and provide a highly personalized, interactive experience for the user on an entertainment platform, whereby the highly personalized and interactive experience is facilitated through information from the user profile comprised of user-inputted information, historical usage data, and outputs from machine learning engines. In one embodiment of the invention, the system is capable of outputting the highly-personalized and interactive recommendations onto a viewing screen while media content is continuously streaming on the same viewing screen.

### BACKGROUND OF THE DISCLOSED EMBODIMENTS

The average user may consume over nine (9) hours of media content per day within the increasingly vast and complex library of content and information available through a multitude of media providers. However, existing providers fail to deliver a level of customization that the user expects, and the new content discovery the user desires. Thus, a new system and method for connecting, customizing, and curating is desired.

Current entertainment platforms such as traditional broadcast television networks transmit content that is interrupted by intermittent commercial breaks that are minimally related to the user's preferences. Similarly, certain internet- and mobile-based entertainment platforms, including over-the-top (“OTT”) streaming services like Hulu® and YouTube® similarly deliver content disrupted by intermittent advertisements, regardless of whether the content is viewed over a traditional web-browser, mobile device, or other platforms. However, these forms of advertisements are disruptive and undermine the user experience. Thus, there exists a need to provide an elevated way to deliver potential revenue-generating content to the entertainment platform in a way that is highly personalized and minimally disruptive to the user.

### SUMMARY OF THE DISCLOSED EMBODIMENTS

The present disclosure discloses systems and methods for user personalization and recommendations schemes that are matched to a user profile and provide a highly personalized, interactive experience for the user on an entertainment platform facilitated through the information from the user profile, resulting in a more comfortable, streamlined, and intuitive entertainment experience for the user. The highly personalized and interactive experience is facilitated through information from the user profile comprised of user-inputted information, historical usage data, and outputs from machine learning engines.

The systems and methods of the present invention include robust services that support curation, e-commerce, recommendations, addressable advertising, interactivity, adaptability to emerging technologies, changing market conditions, consumer trends, and hyper-personalization through targeted personalization of user-optioned selections, as well as historical usage data, and outputs from artificial intelligence (“AI”)/machine learning (“ML”) engines.

In at least one embodiment of the present disclosure, a hyper-personalized entertainment system and method is described, which integrates services including streaming video and simultaneously providing non- and/or minimally-intrusive user-personalized recommendations that are displayed on the same user interface as the streaming video. These user-personalized recommendations include interactive options for the user, for example, options to view information about curated products and services, to place them onto a “locker”, “wish list” or “cart,” or to purchase the highly-curated products and services that are the subject of the content, for example, the option to place an order to purchase a particular alcohol or spirit while viewing a video about that alcohol or spirit.

In another aspect of the invention, the system sets-up a user profile derived from information provided by the user through data entry of information directly into the platform via the registration process, and continuously updates the user profile based on additional or modified information inputted by the user into the system, as well as historical usage data elements automatically recognized and applied by the system to the user profile, and output from AI and ML engines that identifies highly personalized items of interest.

In another aspect of the invention, the system and method curates and recommends products based on a user's profile. The user's profile may be comprised of information including the user's name, address, age, birthdate, location, budget, and other user-inputted preferences, such as preferred locations, preferred spirits, and preferred brands for the example of a spirits-based entertainment system, as well as information gathered through user behavior. Each of these information points, or data elements, are attributed a tag or meta-tag, which can then be run through an AI-based analytics system to predict the user's preferences and output product recommendations directly back to the user while he or she is viewing the content.

In another aspect of the invention, the system includes a number of AI and ML engines with a plurality of recommenders and related personalization schemes. Each recommender/personalizer engine identifies a different type of personalized recommendation for items and interactions within the platform such that the user has a highly-curated experience specific to his or her specific interest, desires, and wants. For example, one recommender/personalizer engine may identify and recommend types of food, and another recommender/personalizer engine may identify types of cars, based on the user profile.

In another aspect of the invention, the recommenders/personalizer engine also scores and weighs the candidate recommendations against a number of AL/ML models. In another aspect of the invention, the recommendation/personalization engine or candidate selector also outputs the recommendations or personalization with associated reasons for the recommendation/personalization of the items. These outputs are part of an associated neural network with continuous, automated feedback loops which continue to refine the recommendations and personalization for each user.

In another aspect of the invention, a computerized method for providing entertainment and e-commerce to a user through a user interface of a computing device is disclosed, the method comprising the steps of: streaming media content on the user interface, wherein the media content includes at least one trigger therein; and when the trigger occurs in the media content, displaying on the user interface information about a product or service that is available for purchase through the user interface, wherein the product or service is related to the streaming media content; wherein the streaming media content continues to be displayed in the user interface at the same time the information is being displayed; and wherein the user may use the user interface to perform an interactive function related to the product or service while the streaming media content continues to be displayed.

In another aspect of the invention, the media content comprises a video.

In another aspect of the invention, the product or service displayed comprises a product or service displayed in the streaming media content.

In another aspect of the invention, the information is displayed in the user interface by providing a display gradient over a portion of the user interface that highlights the information while still allowing the user to view the media content.

In another aspect of the invention, the display gradient incrementally increases or decreases in opacity across the user interface.

In another aspect of the invention, the display gradient comprises a top layer overlay in the user interface, the top layer overlay having a color that becomes increasingly darker across the user interface.

In another aspect of the invention, the interactive function is selected from the group consisting of: purchase the product or service, add the product or service to a virtual shopping cart, add the product or service to a wish list, or add the product or service to a virtual folder, which can later be viewed by the user for later decision-making.

In another aspect of the invention, the product or service is chosen at least in part based upon information supplied by the user.

In another aspect of the invention, the information is selected from the group consisting of: username, user address, user birthdate, user age, user astrological sign, user financial budget, user location, user ethnicity, user travel preferences, user pet preferences, user music interests, user drink preferences, and user food preferences. In another aspect of the invention, the product or service is chosen based at least in part on at least one component part of a product appearing in the media content.

In some embodiments, systems and methods are provided for enhancing a user's entertainment experience through user personalization and recommendations. A system can include various modules such as a voice control module, an emotion detection module, a natural language processing (NLP) module, a personalized response generation module, and a voice recognition system. These modules enable user interaction with an entertainment platform using voice commands, analyze vocal characteristics to detect the user's emotions, interpret user commands, generate personalized responses based on emotions and preferences, and capture and analyze voice commands.

Some embodiments can include additional components such as a user profile management module for capturing and storing user attributes, a data collection and analysis module for collecting and analyzing user behavior and preferences, and ONE OR MORE ARTIFICIAL INTELLIGENCE AND/OR MACHINE LEARNING (AI/ML) engines for generating accurate and personalized recommendations. It also incorporates a content metadata and tagging module, a collaborative filtering and content-based filtering module, a recommendation candidate selection module, and a personalization and tailoring module to customize recommendations based on the user's profile and preferences. The system utilizes a continuous feedback loop to incorporate user feedback and evolving preferences, and it is designed with a scalable architecture and cloud deployment to ensure performance and accommodate increasing user demands.

In some embodiments, the disclosure describes a hyper-personalized entertainment system and method that integrates streaming video with non- and/or minimally intrusive user-personalized recommendations. These recommendations are displayed on the same user interface as the streaming video, providing interactive options for users to view information about curated products and services, add them to a wishlist or cart, or make purchases. The system leverages user profiles, preferences, historical usage data, and cultural background to generate accurate and relevant recommendations, enhancing the user's entertainment experience.

Embodiments described herein can provide a highly personalized and interactive experience for users on an entertainment platform. By utilizing voice commands, emotion detection, natural language processing, and personalized response generation, the system enables users to interact with the platform in a comfortable and intuitive manner. The system incorporates user profiles, preferences, and real-time interactions to generate accurate and personalized recommendations, resulting in an enhanced entertainment experience. Additionally, the system includes features such as content metadata and tagging, collaborative filtering, recommendation candidate selection, and personalization and tailoring, which further optimize the recommendations for individual users. The system also incorporates a continuous feedback loop, scalable architecture, and cloud deployment to ensure system performance and accommodate growing user demands.

In another aspect, the system integrates augmented reality (AR) and enhanced sensory experiences into the personalized recommendation system. This integration allows for overlaying virtual objects onto the user's real-world environment using AR technology. The system utilizes computer vision algorithms, motion tracking, and spatial mapping techniques to accurately align virtual content with the user's physical surroundings, creating an immersive AR experience. The system also incorporates olfactory and gustatory stimuli, delivering synchronized scent and taste experiences to users through specialized hardware and algorithms. The personalization and sensory preference analysis module analyzes user profiles, historical interactions, and contextual data to generate personalized scent and taste profiles, providing a highly personalized sensory experience. The integration of AR and enhanced sensory experiences enhances immersion, realism, and engagement for users.

### BRIEF DESCRIPTION OF DRAWINGS

The present invention will become more fully understood from the detailed description and the accompanying drawings, wherein:

FIG. 1A illustrates a system for generating personalized user recommendations, according to an embodiment.

FIG. 2A illustrates an example of a user interface (“UI”) requesting user information for a platform related to spirits, according to some embodiments.

FIG. 2B illustrates an example of a UI showing minimally disruptive interactive options that the user may use to interact with the system while continuing to view the content on the same viewing screen, according to some embodiments.

FIG. 2C illustrates an example of a portion of a UI showing interactive options that the user may use to interact with the system, according to some embodiments.

FIG. 2D illustrates an example of a portion of a UI displaying product information and options, according to some embodiments.

FIGS. 2E-2I illustrate examples of a portion of a UI displaying the various phases of purchasing within the streaming platform, according to some embodiments.

FIG. 2J illustrates an example of a UI displaying the wish list, according to some embodiments.

FIG. 2K illustrates an example of a UI displaying additional details upon clicking into the wish list item.

FIG. 2L illustrates an example of a UI displaying the quick-buy option within the wish list.

FIG. 3 depicts a flow diagram describing the system depicted in an embodiment of the invention.

FIG. 4 illustrates a system for generating personalized user recommendations, according to an embodiment.

FIG. 5 illustrates a system for generating personalized user recommendations, according to an embodiment.

FIG. 6 illustrates a system for generating personalized user recommendations, according to an embodiment.

FIG. 7 illustrates a system for generating personalized user recommendations, according to an embodiment.

FIG. 8 illustrates a system for generating personalized user recommendations, according to an embodiment.

### DETAILED DESCRIPTION OF THE DISCLOSED EMBODIMENTS

For the purposes of promoting an understanding of the principles of the present disclosure, reference will now be made to various embodiments of the present disclosure, and specific language will be used to describe the same. It will nevertheless be understood that no limitation of the scope of this disclosure is thereby intended.

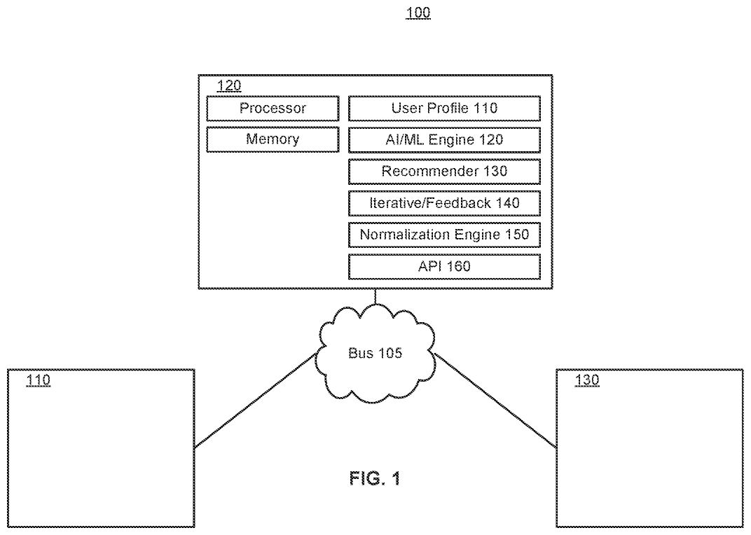

FIG. 1 illustrates a system 100 for enhancing a user's 110 entertainment experience, according to an embodiment. System 100 can include of an entertainment platform 120 that can be fully customizable and capable of capturing and analyzing user-based information to predict user-behavior and recommend highly-curated products, content, experiences or other services. In some embodiments, a user may enter data elements into the system as part of a user profile 110, including but not limited to the user name, address, birthdate, age, astrological sign, financial budget, location, ethnic and cultural makeup, and certain preferences, including travel preferences such as whether the user has a stronger propensity to travel to a certain region or destination over others (e.g., prefer the Bahamas over Greece), pet and music interests, drinks and food likes and pairings based on their molecular structure, and other user preferences.

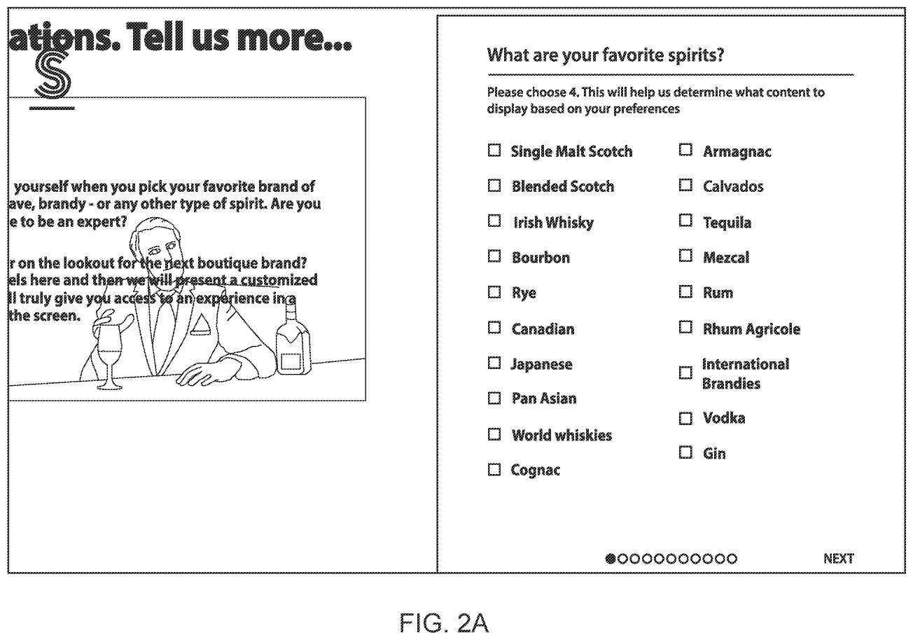

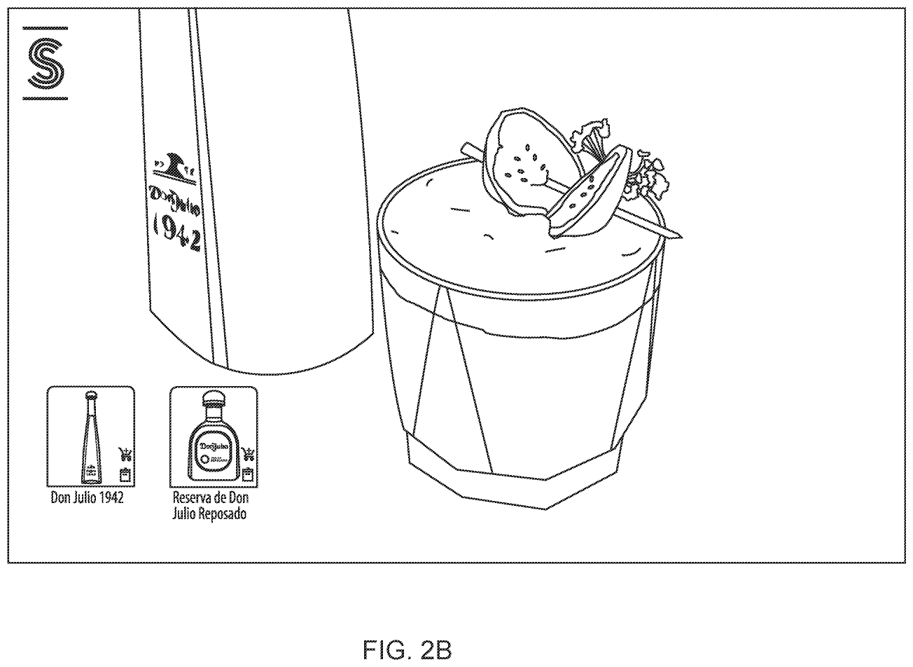

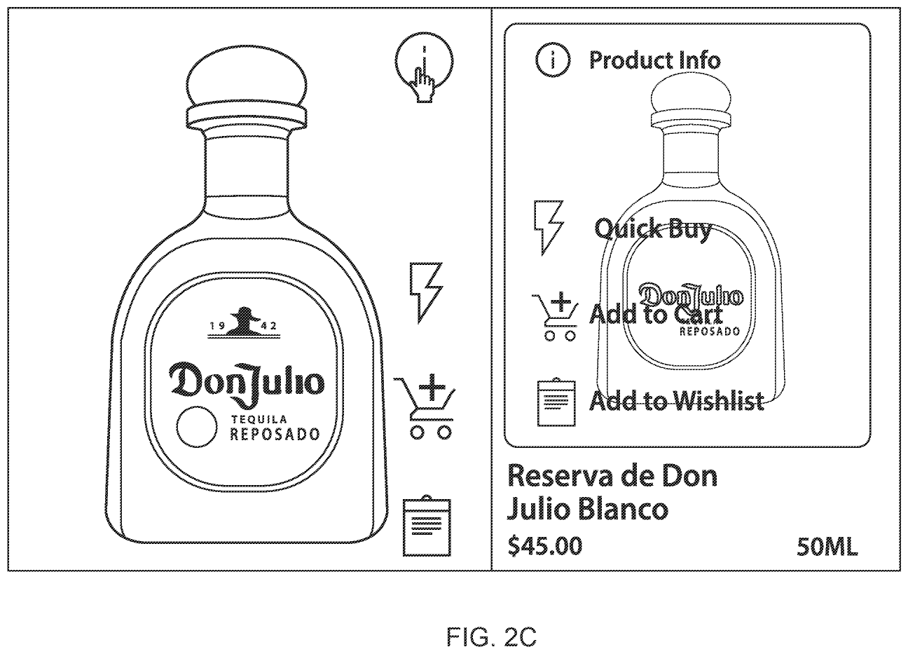

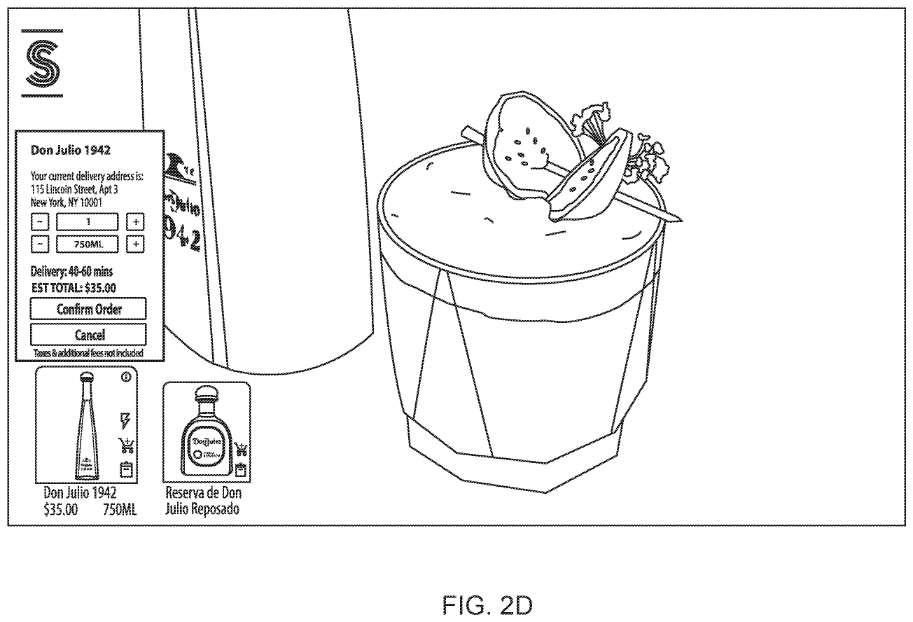

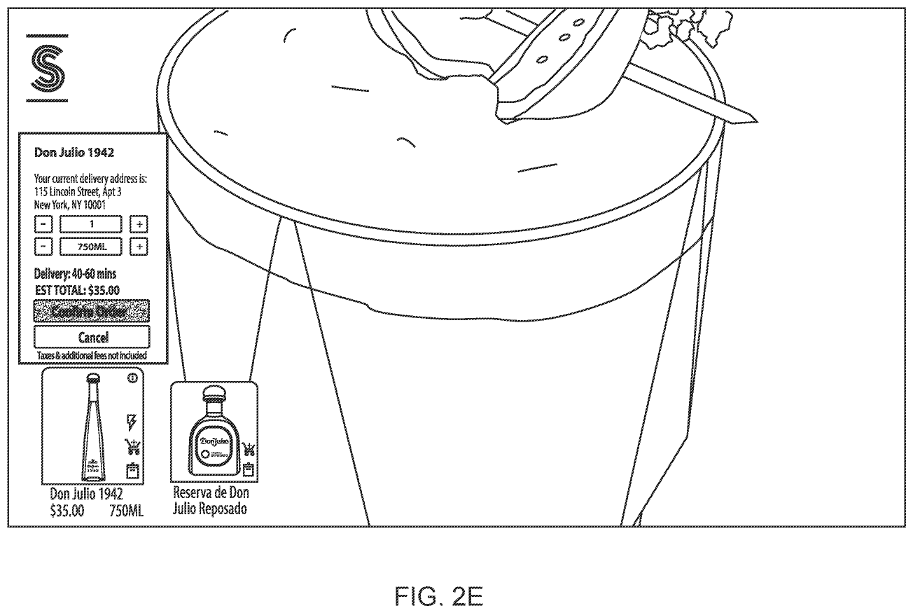

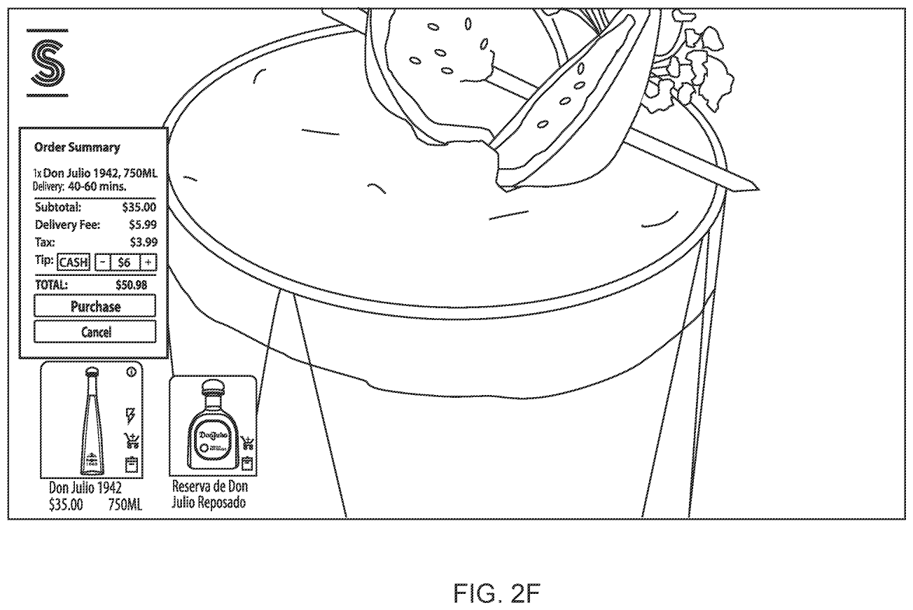

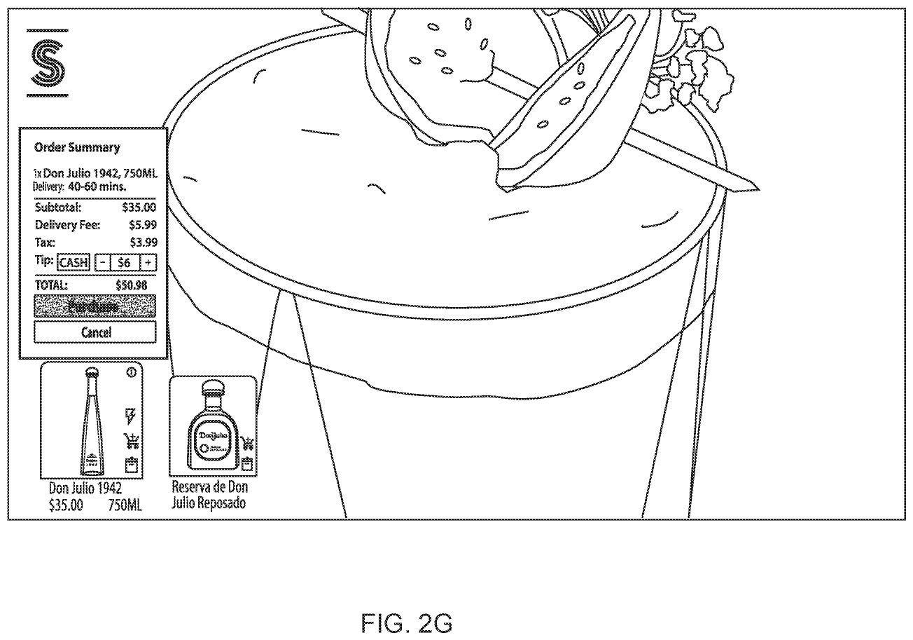

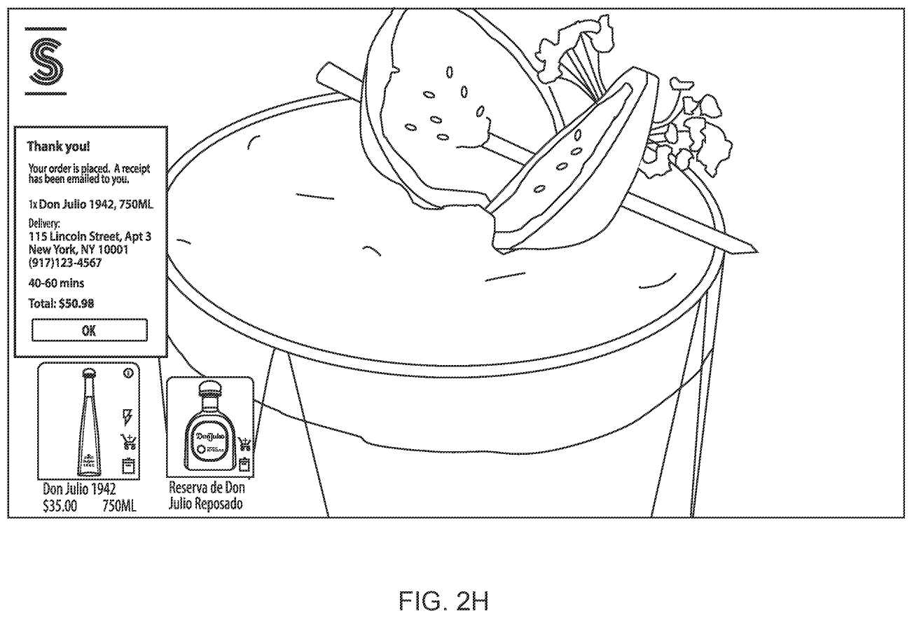

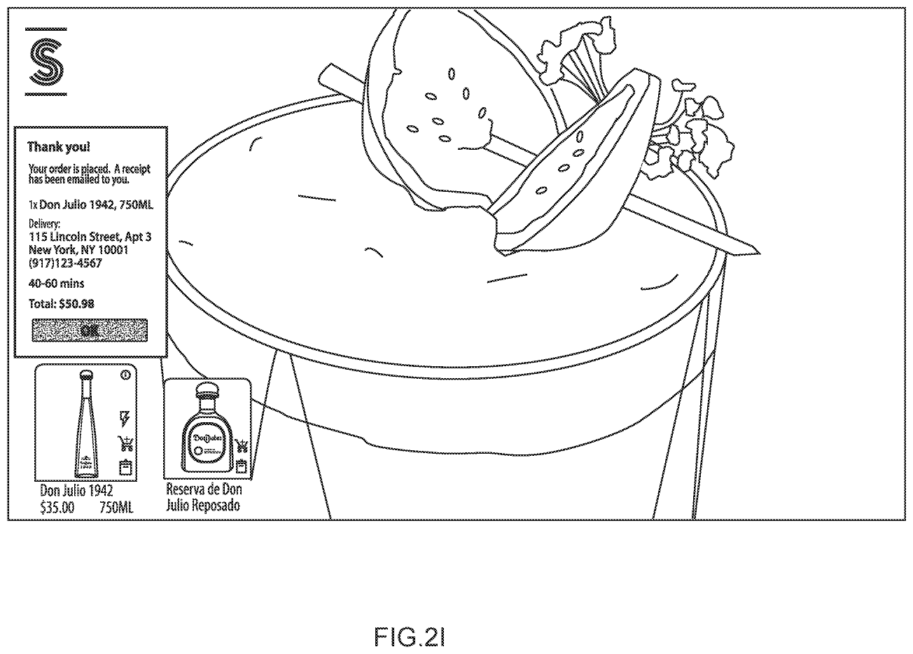

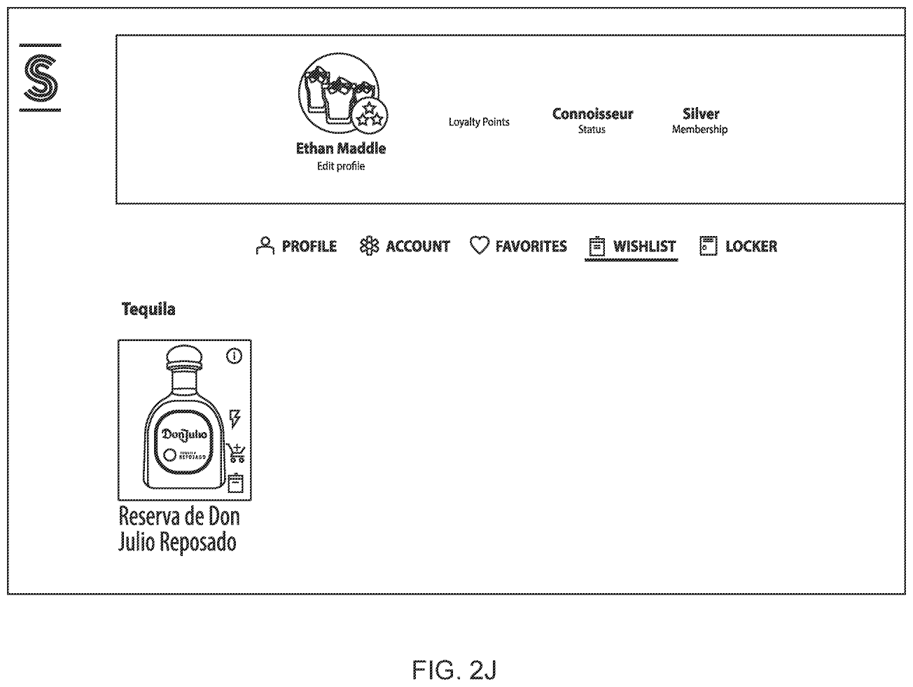

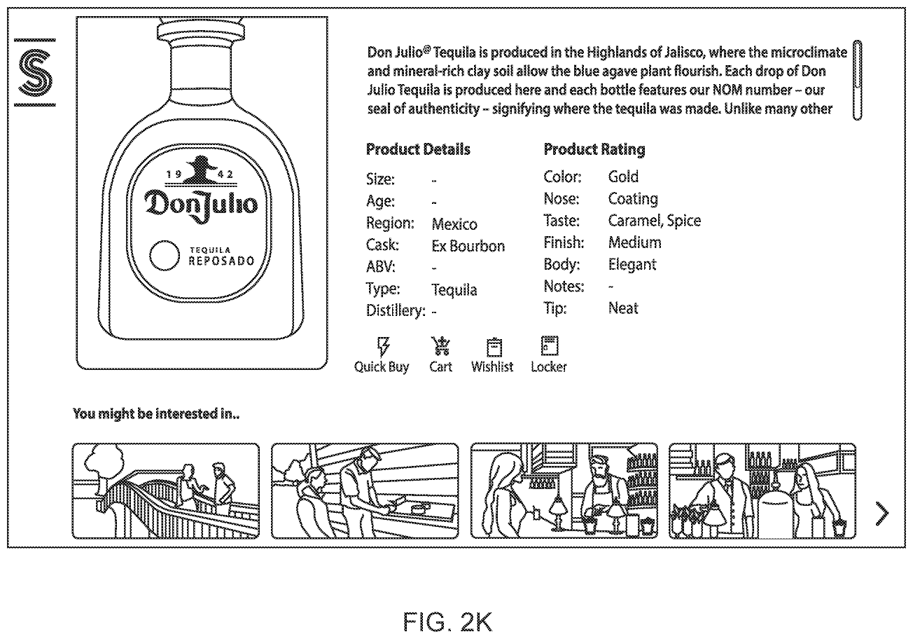

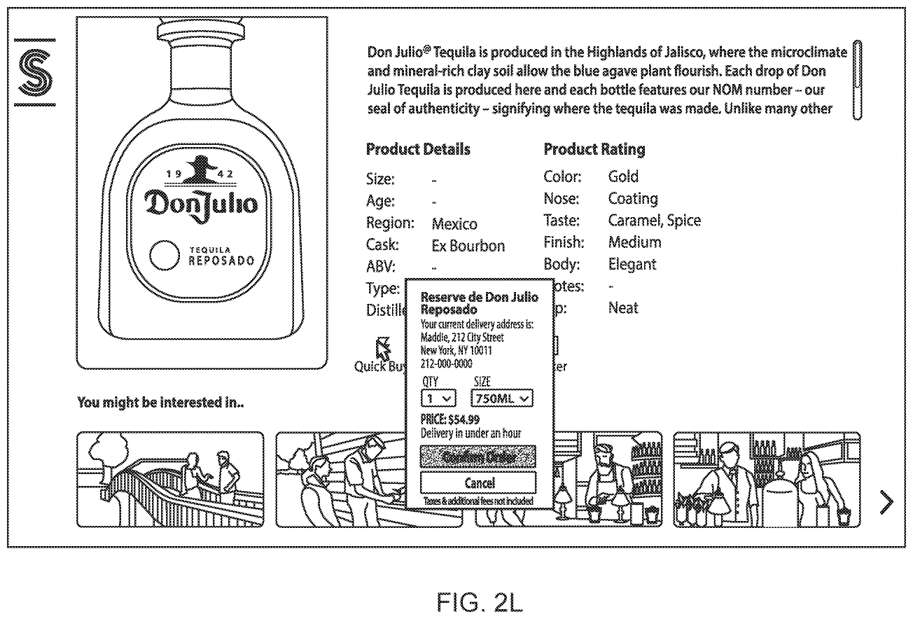

Selection options for user preferences may vary based on the purpose of the entertainment platform, but may include user preferences on atmosphere (e.g., quiet, loud, etc.), environment (e.g., sports venue, outdoors, restaurants, etc.), preferred beverages, food, and the like. An example of a User Interface (“UI”) 200 requesting this information for a platform related to spirits is shown in FIG. 2A.

The platform may be viewed over an internet web-browser, a mobile device, or other outlets, including but not limited to Roku®, Amazon Fire®, Apple TV®, Vizio®, TiVo®, Western Digital®, Netgear®, smart TVs, including Samsung®, Panasonic®, LG®, and more. The entertainment platform is capable of streaming media content, including but not limited to video files of the user's preference. In some embodiments, streaming media content may be streamed by a content provider 120. The entertainment platform 120 may be highly specialized in some embodiments, for example, a channel devoted to high-end alcohol and spirit products, or may include multiple channels, or channels devoted to broader subject matter. Based on the subject matter and particular requirements of the subject matter, different user preferences may be selected. For example, in the case of alcohol or spirits, a user profile 110 may include an age-gate, upon which those under the legally-required age may not be permitted to participate.

In some embodiments, during the streaming of the media content, the platform is capable of automatically displaying curated information when internally triggered by a certain aspect of the content, which may be configured in advance by the content provider 120 in some embodiments. For example, in the spirits area, a content related to whiskey may trigger a certain whiskey's information to appear when that particular whiskey is mentioned in the content, either through visual, auditory, or other cues. The product information is displayed in such a way as to minimally disrupt the streaming of the content. This is achieved by, for example, providing a display gradient over a portion of the screen that highlights the product information while still allowing the user to easily view the content in some embodiments. The display gradient may gradually (incrementally) increase or decrease in opacity across the viewing screen. As one example, the display may appear visually darker in color and gradually become a more opaque variation of the same color. This may be accomplished, for example, by having a top layer overlay technique that brings more visual attention to the recommended items that are presented to the viewer.

The product information may be displayed in a prominent, yet non-distracting position and size, for example, by displaying the product information in one corner or the lower or upper portion of the viewing screen, and having a gradient display to highlight the product while minimizing distraction for the viewer who may wish to continue to view the content on the same viewing screen. FIG. 2B shows an exemplary User Interface (“UI”) 200 demonstrating some of the above described capabilities.

In some embodiments, the entertainment system described above includes interactive options associated with the product information that is displayed during the streaming of the media content on the same viewing screen. These include, for example, options to purchase the product, add it to a virtual shopping cart, add it to a wish list, or add it to another virtual folder, which can later be viewed by the user for later decision-making. In some embodiments, these options may be enabled by including an icon alongside the product information to easily allow the user to select the desired option, as shown for example in FIG. 2C. In the example involving the option to purchase the product, a user who seeks to purchase a product associated with the content has the option to immediately purchase the product by selecting the quantity, confirming the displayed shipping address (previously supplied by the user in his profile) and then selecting the purchase option. FIGS. 2D-2I illustrate one embodiment of this system and process. Once product information has appeared on the screen, a user may click, touch, hover, select, or otherwise indicate (depending on the platform) the sub-UI for additional options. For example, FIG. 2D shows that the user has selected the first curated product. Upon the user's selection of the “quick-buy” icon, additional product information is displayed, providing options for quantity and size of the product, as well as options to confirm or cancel the order. In addition, because the user has already entered certain information and preferences into his or her profile, information and preferences already known to the system are pre-populated and/or calculated, in this case, the delivery address, billing information, and other metrics required to complete the purchase, including an estimated delivery time of the product. FIG. 2D shows that the user has selected to confirm the order. FIG. F displays an Order Summary UI, which provides information summarizing the order, such as the name of the product, the quantity, size, delivery estimate, the price, as well as an option to tip, and finally an option to Purchase or Cancel the order. FIG. 2G shows that the user has selected to Purchase the order. FIG. 2H displays a UI confirming the purchase. FIG. 9 shows that the user has selected the OK icon, indicating acceptance of the order and confirmation. It may be appreciated in FIGS. 2D-2I that while the user is receiving product information, deciding to purchase the product, placing the order, and receiving confirmation of the order and delivery estimate (all within a minimally disruptive interface), the content continues to stream, thus delivering uninterrupted content to the user. The user may alternatively place the product into his or her shopping cart, so that they may later confirm the purchase details and place the order. The user may alternatively place the product into the wish list, upon which the user can later decide whether to purchase the product. This product information interface is apparent during the same time the user is simultaneously viewing the content and on the same viewing screen as the streaming media content, thus, minimizing the disruptions to content delivery, and maximizing the ease at which a user may purchase products (or perform other secondary interactions with the UI, such as viewing additional information, populating a shopping cart, saving product information to a wish list, etc.). FIGS. 2J-2L show how a product placed into a wish list may later be purchased.

In some embodiments, the entertainment system includes hyper-personalization schemes that provide targeted personalization based on user-optioned selections, social listening, content and context data analysis, and identified cross-channel insights. In one instance, the entertainment system and method curates and recommends products based on the user profile. The user profile 110 may be comprised of data elements inputted by the user, and information collected through the user's interaction with the entertainment system, as collected and analyzed by the system. Each of these information points, or data elements, are attributed a tag or meta-tag, which can then be run through an AWL-based analytics system 120 to further predict the user's preferences and output recommendations directly back to the user while he or she is viewing the content, thus providing a highly-personalized experience. In addition, each piece of media content may be attributed with certain metadata tag attributes like name, date, topic, and other unique attributes relevant to the curating process for a particular recommendation, such as for a particular product. These tags can then be linked to relevant products and further associated with certain users with preferences aligned with those attributes. As one example in the alcohol/spirits industry, a particular content such as a video about an alcohol originating from a Spanish-speaking country may have attributes associated with the content, including tags for languages, country of origin, or spirit-type. The tags or meta-tags are also capable of deep tagging, which provides a more granular level of identifying attributes of items and of content in the user profile. Such back-end information associated with the content may be linked to particular products and/or users, thus improving opportunities to provide better insights to the user and/or the content or product providers.

In some embodiments, the highly personalized and interactive experience is facilitated through the information from the user profile comprised of user-inputted information, historical data, and information created by ML engines. The user's profile is derived from information provided by the user through data entry of information directly into the platform via the registration process and/or later entries and adjustments, updates into their profile as well as historical usage data elements automatically associated with their profile by the system.

In some embodiments the historical data includes both application/platform specific direct user activity data and profile-provided data, as well as external data and data groupings that are related to each user by virtue of how they are manually or algorithmically grouped in accordance with the overall profile segments in relation to other user profiles that are grouped with similar attributes. Each attribute is aligned with a corresponding base hypothesis that is either programmed or derived through machine learning models and then capable of evolving as it learns more about a user's or group (cohort) of users' activities over time. For example, if it is discovered that a significant percentage of users who like Irish whiskey also like golf, then the system would be likely to recommend golf content to other users who have self-identified as liking Irish whiskey, but who have not self-identified a preference for golf.

In some embodiments, certain data elements such as user-inputted information including user name, birthdate, astrological sign, financial budget, geolocation, ethnic and cultural makeup, travel preferences, pet and music interests, drinks and food likes and pairings based on their component parts or molecular structure (for example in the spirits or food categories, subdividing attributes into their smaller parts to accomplish a better and more creative alignment of recommendations for flavor and taste pairings (those who like whiskey may enjoy other wood-aged spirits, those who like lasagna may enjoy other tomato-based pasta dishes, etc.)), are aligned with other data elements such as user likes and dislikes, colors, and smells, to create highly-personalized interactive experiences within the platform such as during video content watching, audio podcast listening, e-commerce purchases within the application, and select items to service the user in a highly personalized manner that include related recommendations. The system records the indicated preferences of all users by, for example, recording what items they purchase through the platform. If the system detects a correlation between preference for a certain product by users who are associated with the same astrological sign and the same ethnicity, then the system will recommend that product to other users who share that astrological sign and ethnicity (as determined by the user profiles).

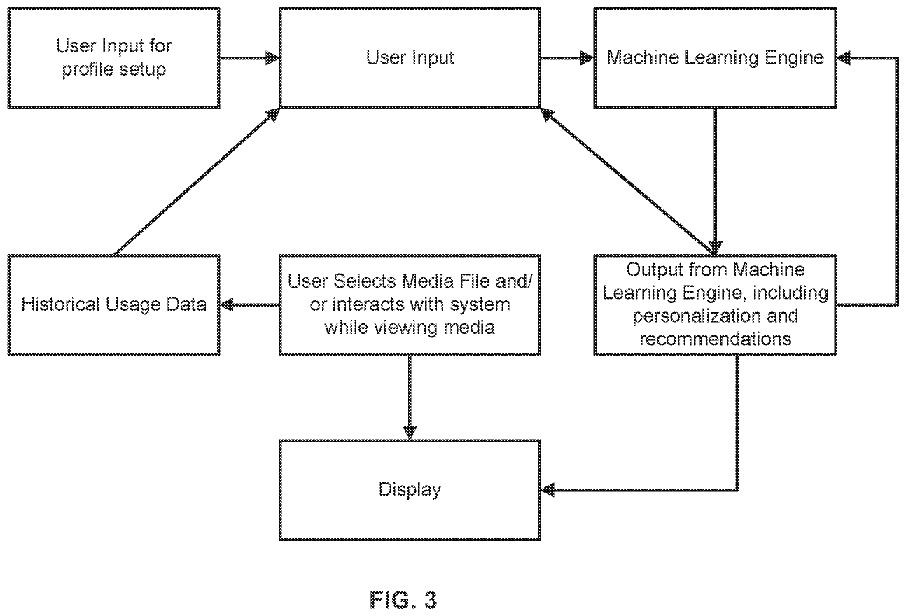

FIG. 3 shows one non-limiting embodiment of a methodology for personalized user recommendations. As shown in FIG. 3, a user inputs information during the user registration process or at any time after the user has registered onto a platform. This information is part of the user profile. Upon setting up a user profile, the user may browse the platform and select a media file to view, which is then displayed to the user on a user interface. While viewing the media file, the user may be prompted to interact with the platform, including for example, by selecting to view more information about a product, or to purchase the product, among other possible options. The system captures and analyzes the user's interactions with the system, and this information, along with other instances in which the user has interacted with the system will be part of the historical data that becomes a part of the user profile. The information from the user profile is sent to one or more AI/ML engines 120. The AI/ML engines 120 output additional information, including recommendations and personalization, which are displayed to the user on the user interface. The output from the AI/ML engine 120 can also form part of a continuous feedback loop 140 with the one or more AI/ML engines 120.

In some embodiments, the system includes a number of AI and ML engines 120 with a plurality of recommenders 130 and related personalization schemes. Each recommender/personalizer engine identifies a different type of reason for recommending and personalizing all items and interactions within the platform in a way that the user feels is properly curated to their specific interest, desires, and wants. In one example, each recommender/personalizer 130 retrieves item preference data and generates candidate recommenders/personalizers responsive to a subset of that data that provides the user with a highly personalized item of interest that is either placed in their wish list for later consideration or is systematically acted upon in an immediate and appropriate way on behalf of the user based on their profile settings to do so. FIG. 3 shows an example of a UI 300 demonstrating some of the above described options. For example, the right-hand portion of FIG. 3 displays clickable options for obtaining product information, purchasing the product while streaming content (“quick-buy”), adding to a cart, or adding to a wish list. Each of the icons and options may be added, deleted, edited, and/or otherwise customized based on the needs of the platform.

In another aspect of the invention, the system also includes AI/ML and modeling capabilities that are highly scalable and can generate billions of predictions daily, and serve those predictions in real-time and at high-throughput using powerful algorithms to create machine learning models by finding patterns in all collected data, to help determine and forecast predictive user patterns in support of personalization options and omni-channel opportunities. For example, the AI/ML engine may look at both structured and unstructured data. It may be comprised of a continuous iterative process learning from user preference data rather than through explicit programming. As the algorithms ingest training data, the AI/MI engine 120 may produce more precise models based on that data and related hypothesis. The machine learning model or an enhancement to an existing model is the output generated. The AI/ML architecture enables models to train on data sets before being deployed. Some models are online and continuous, operating on the live data of the system, while others are off line where they continue to refine and improve on both the hypothesis as well as the related data algorithms for all aspects of the recommender and personalizers. This iterative process 140 of online models leads to an improvement in the types of associations made between data elements. Due to their complexity and size, these patterns and associations can easily be overlooked by human observation. After a model has been trained, it can be used in real time (online) to learn from the system data. The improvements in accuracy are a result of the training process and automation that are part of the AI/ML process. The algorithms receive feedback from the data analysis, providing the user with the best recommendation and personalization outcomes based on their profile and historical interaction within the application platform. The system uses neural networks to help automatically infer rules for recognizing patterns that the network can more quickly learn more about to improve recommender/personalization accuracy.

In some embodiments, the recommender/personalizer engines also score and weight the candidate recommendations against a number of AI/ML models. The recommenders 130 encompass a class of techniques and algorithms that suggest “relevant” items, content, opportunities, options, and markets to the user. The recommenders are generally divided into categories depending on a base hypothesis (one example of a hypothesis being that bourbon lovers overall or specifically are also those who also like BBQ and old American “muscle” cars). These collaborative filtering and content-based elements are modules of the architecture. The recommendations are built around items, whereas personalization is built around users' singular (individual) or combined (cohort) preferences. There is some overlap, but the more informed (through qualified internal and external data) and well designed and tuned the recommender engines/modules become the better the alignment accuracy to a user personalization the present methods become. The number of these modules is dependent on the types of recommender and personalizers needed for a particular category or group of categories of user or market needs. For example, different modules may be designed to examine data and make recommendations for spirits, cars, cigars, food, etc.

In certain cases, a normalization engine 150 normalizes the scores of the candidate recommendation or personalization provided by the results from the models with a more contextual-normalization factor that is further or better aligned with the user or group of users profiles. Using normalization of the data results in reduced redundancy and improves the overall data integrity. The data may be further optimized to determine the best possible presentation to a broad set of users based on lead market categories within the users' profile. The purpose of the optimization is not to just seek the best presentation for each individual user aligned with their profile, but to also seek to provide optimization for the audience as a cohort group as related to the application layout/design, membership and shopping cart conversion workflow/pathing, product item opportunity, non-intrusive advertising integration as well as entertainment content structure and story lines.

Recommenders 130 are used for decisions based on whole audience behaviors using approaches similar to those used in optimization models but applied to individual pieces of content, items, locations, etc. Built around a technique known as collaborative filtering, the recommender engines/modules compare similar sets of audiences cohorts, users with similar profiles, etc. in terms of trending, most popular, most likely to be user actionable clicked, viewed, researched, purchased, most closely related to another item, for items, content, and opportunity for those users to interact. For example, the algorithms may find that a large percentage of users who buy a certain type of spirit or cocktail also frequently interact watch, taste, buy a particular content or item category and therefore the recommender will recommend those items together as part of users' interactive content viewing experience, search and checkout flow. As with optimization solutions, the recommendation solutions of the presently disclosed embodiments form suggestions based on behaviors across large, medium and smaller groups as a precursor to tailoring results for the individual user.

The personalization approach of the presently disclosed embodiments is used for tailoring results content, product, interactions, user flows to individuals. These resultants are combined with the aforementioned methods and architecture from the user's behavior within the application/platform over a period of time. Collected through the use of tracking scripts, user personalization provided data and interaction activity solutions, this data builds a comprehensive profile of each user over a period of time, and in some cases, creates detailed profiles of all the items and content available to users as well.

These item and content profiles serve as additional inputs in user profiles. For example, understanding the topicality of a set of items and content can inform the profile of a particular user who likes to consume the items and content about single malt scotch, automotive prices or Ireland. The profile also includes information about the geolocation, time of day, device, application, browser, etc. of an individual user. The system can also unify the interactive profile of an individual across multiple devices. All of this becomes additional data points that are used to create a personalized interaction with the user, which might include product, content, integrated minimally integrated advertisements or offers.

A recommendation/personalization candidate selector selects at least a portion of the candidate recommendations based on the normalized scores and weight factors into data combinational rules for recommendations/personalization to the user. The recommendation/personalization candidate selector also outputs the recommendations/personalization with associated reasons for the recommendation/personalization of the items to an associated neural network with a continuous, automated feedback loop which continues to refine the recommendations/personalization for each user.

In another aspect of the invention, the system 100 includes common runtime services and libraries that power micro services on a cloud platform foundation and technology stack for the majority of the services, application libraries and application containers. These provide service discovery through distributed configuration, resilient and intelligent inter-process and service communications while providing reliability beyond single service calls, to isolate latency and fault tolerance at runtime.

In another aspect of the invention, the system 100 also includes a robust set of Application Program Interfaces “APIs” and Connective Integrations 160 for technology and service partners that provide a unique experience to the user in the form of e-commerce, live interactive events, discovery services, content and other value-added opportunities without having to leave the environment.

In another aspect of the invention, the system also includes data persistence features, which allow storing and serving data in the cloud with the ability to handle significant amounts of data operations per day and support the growth of the user-base and the system.

In another aspect of the invention, the system also includes a Content Delivery Network “CDN”, which allows routing traffic via global CDNs to deliver higher availability with a global presence.

In another aspect of the invention, the architecture for the entertainment system and method described above may be set-up using currently existing platforms, including Amazon's Web Services “AWS” Cloud Computing Services, as well as currently existing technology platforms, such as the following frameworks: .NET, HTML, HTML Plus, Java, JavaScript, React, Ionic. For example, FIG. 2A shows an exemplary User Device User Interface UI utilizing AWS Route 53, AWS EC2 for elastic load balancing, and AWS S3.

### Recommendation System and Methodology

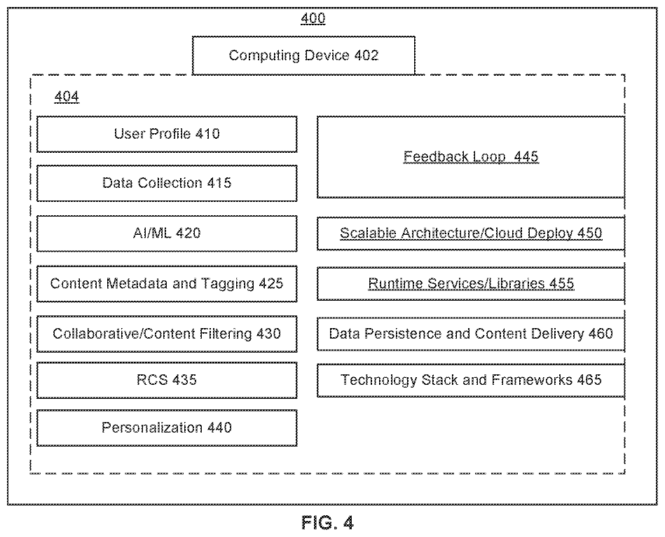

FIG. 4 depicts another embodiment of a recommendation system, which can include one or more aspects described above. In one non-limiting embodiment, Recommendation System 400 can be configured to enhance a user's entertainment experience by providing highly curated recommendations for products, content, experiences, or other services. The system utilizes user profiles, data collection and analysis, AI/ML engines, and advanced algorithms to generate accurate and personalized recommendations.

In another embodiment, Recommendation System 400 can be provided to enhance a user's entertainment experience by predicting user behavior and recommending highly curated products, content, experiences, or services. Recommendation system 400 can include one or more modules. In this disclosure a module can be understood as a distinct component configured to perform specific functions or tasks within the system. It encapsulates a set of related functionalities and can be designed to handle various aspects of the disclosed embodiments, including at least data processing, analysis, or interaction.

In some embodiments Recommendation System 400 can include User Profile Management Module 410, Data Collection and Analysis Module 415, AI/ML Engine(s) 420, Content Metadata and Tagging Module 425, Collaborative Filtering and Content-Based Filtering Module 430, Recommendation Candidate Selection (RCS) Module 435, Personalization and Tailoring Module 440, Continuous Feedback Loop 445, Scalable Architecture and Cloud Deployment 450, Runtime Services and Libraries 455, Data Persistence and Content Delivery 460, and Technology Stack and Frameworks 465.

In some embodiments, Recommendation System 400 includes User Profile Management Module 410, which can capture and store user attributes to create personalized profiles. User Profile Management Module 410 can be configured to store user attributes such as username, address, birthdate, age, astrological sign, financial budget, location, ethnic and cultural makeup, travel preferences, pet and music interests, drinks and food preferences based on molecular structure, and other relevant user preferences. The module enables data entry, updates, and adjustments to the user profile, facilitating a comprehensive understanding of each user's preferences and characteristics.

Data Collection and Analysis Module 415 plays a crucial role in Recommendation System 400. This module can collect user behavior, preferences, and historical data, tracking user interactions, content consumption patterns, purchase history, and user-provided feedback. Data Collection and Analysis Module 415 can be configured to employ AI and ML techniques to process and analyze the collected data, identifying user preferences, interests, and trends. By continuously learning from the data, the module enhances the accuracy of the recommendations provided by the system.

AI/ML Engines 420 can be implemented in Recommendation System 400, utilizing advanced algorithms and techniques to generate accurate and personalized recommendations. The engines analyze the collected data, identify user preferences, and predict future preferences. AI/ML Engines 420 continuously learn and refine their models based on user interactions, feedback, and evolving user profiles. The output from these engines serves as the basis for the recommendation generation process.

AI/ML Engines 420 can be implemented in engines can be implemented using various platforms and frameworks suitable for machine learning including, but not limited to, TensorFlow, PyTorch, or scikit-learn.

In one non-limiting example, AI/ML Engines Module 420 can be implemented using TensorFlow and Keras, which enables the development and deployment of artificial intelligence and machine learning models for various applications. By leveraging the TensorFlow framework and Keras' Sequential API, the AI/ML Engines Module facilitates the implementation of advanced machine learning algorithms and techniques, enhancing the accuracy and performance of predictive models.

AI/ML Engines Module can utilize TensorFlow and its associated libraries, to provide a powerful and flexible environment for data preparation, model architecture definition, model training, and prediction generation. The integration of Keras' Sequential API allows for the efficient construction of neural networks and facilitates the development of complex machine learning models.

Prior to model development, appropriate data preparation can be implemented. The AI/ML Engines Module supports the preparation of user profiles, historical data, and contextual information. User profiles capture relevant attributes such as demographic information, preferences, and behaviors. Historical data represents past interactions, purchases, or other relevant user activities. Contextual information includes time-based data or environmental factors that can influence model predictions. These datasets can be preprocessed and structured to facilitate model training and testing.

The AI/ML Engines Module can leverage Keras' Sequential API to define and compile the model architecture. This API allows for the sequential assembly of layers in a neural network. Different types of layers, such as dense layers, convolutional layers, or recurrent layers, can be added and configured. The model architecture can be defined by specifying the number and type of layers, the activation functions, and the input and output dimensions. Once the architecture is defined, the model can be compiled with an appropriate optimizer, loss function, and metrics for evaluation.

The prepared data can be used to train the model through the fit function provided by TensorFlow. During the training process, the model learns to recognize patterns, correlations, and features within the data. By iteratively adjusting the model's parameters using optimization algorithms, the model optimizes its performance and enhances its ability to make accurate predictions. Training parameters, such as the number of epochs, batch size, and learning rate, can be specified to control the training process and improve convergence.

Once the model is trained, it can be utilized to make predictions on test data using the predict function. Test data represents unseen or future instances that require predictions. The trained model takes the test data as input and generates predictions based on the patterns it has learned during training. The predictions can provide valuable insights and enable decision-making in various applications, such as recommendation systems, user behavior analysis, or personalized content delivery.

In summary, the AI/ML Engines Module utilizing TensorFlow and Keras' Sequential API offers a comprehensive solution for the development, training, and deployment of artificial intelligence and machine learning models. By providing the necessary functionalities for installation and setup, data preparation, model architecture definition, model training, and prediction generation, the module empowers users to create accurate and efficient predictive models. The integration of TensorFlow and Keras enables the implementation of complex machine learning algorithms, further enhancing the capabilities of intelligent applications across various domains.

Although specific embodiments have been illustrated and described, it will be appreciated by those skilled in the art that various modifications can be made without departing from the scope of the disclosure. The embodiments are not intended to be limiting, and the true scope and spirit of the disclosure are set forth in the appended claims.

Content Metadata and Tagging Module 425 can associate relevant metadata and tags with media content items in Recommendation System 400. Each content item can be attributed with metadata tags such as name, date, topic, and unique attributes. Deep tagging techniques can be utilized to provide a granular level of identification for content attributes. These tags and metadata attributes can be linked to relevant products and associated with user preferences, facilitating targeted recommendations.

Collaborative Filtering and Content-Based Filtering Module 430 employs collaborative filtering and content-based filtering techniques to generate accurate and relevant recommendations. Collaborative filtering compares user preferences and behaviors to identify similarities and recommend items that users with similar profiles have found appealing. Content-based filtering analyzes the attributes and characteristics of items to recommend similar items based on user preferences. These filtering techniques contribute to the accuracy and relevance of the recommendations provided by Recommendation System 400.

In a non-limiting example, Collaborative Filtering and Content-Based Filtering Module 430 can be implemented using Apache Spark MLlib for recommendation systems. The module enables the generation of accurate and personalized recommendations by leveraging collaborative filtering and content-based filtering techniques. The implementation involves the installation and setup of Apache Spark, creation of a SparkSession for interaction, data preparation, collaborative filtering using the Alternating Least Squares (ALS) algorithm, content-based filtering employing the Word2Vec algorithm, and utilization of the generated recommendations in the system.

Collaborative filtering can compare user preferences and behaviors to identify similarities and recommend items that similar users have found appealing. Content-based filtering can analyze item attributes and recommends similar items based on user preferences. Apache Spark MLlib provides a powerful framework for implementing these filtering techniques and generating accurate recommendations.

In a non-limiting example, to implement the Collaborative Filtering and Content-Based Filtering Module 430, Apache Spark can be implemented and the necessary libraries, including SparkSession, can be imported to facilitate interaction with Spark.

A SparkSession can be created to establish a connection with the Spark cluster. The SparkSession provides an entry point for accessing various Spark functionalities and enables interaction with the MLlib library. The module requires user-item interaction data and item attributes for collaborative filtering and content-based filtering, respectively. User-item interaction data typically includes information about user preferences, ratings, or historical interactions. Item attributes encompass descriptive features of the items such as metadata, tags, or textual content. Prior to filtering, the data can be preprocessed and formatted to ensure compatibility with the MLlib algorithms.

Continuing this example, collaborative filtering can be implemented using the Alternating Least Squares (ALS) algorithm available in Apache Spark MLlib. ALS is a matrix factorization technique that predicts missing entries in a user-item interaction matrix based on the observed entries. It leverages iterative computations to learn latent factors that capture user preferences and item characteristics. The Collaborative Filtering module applies ALS to the prepared user-item interaction data to generate accurate recommendations.

Content-based filtering can utilize the Word2Vec algorithm, for example, in Apache Spark MLlib. Word2Vec represents items and their attributes as distributed vectors in a high-dimensional space. It captures semantic relationships between items by analyzing their attribute similarities. The Content-Based Filtering module applies Word2Vec to the prepared item attribute data, generating item embeddings that serve as the basis for content-based recommendations.

Once the collaborative filtering and content-based filtering stages are completed, the generated recommendations can be utilized in the recommendation system. The recommendations can be tailored to each user's preferences and interests, enhancing the overall user experience by providing accurate and personalized suggestions for products, content, experiences, or services.

Recommendation Candidate Selection (RCS) Module 435 selects a subset of candidate recommendations based on normalized scores and weighted factors. This module combines the outputs from AI/ML models, contextual normalization, and user-specific profiles. The selected recommendations, along with associated reasons, can then be passed to the Personalization and Tailoring Module 440.

RCS Module 435 can be configured to curate highly personalized recommendations for users. In some embodiments, RCS Module 435 can be configured to curate personalized recommendations within the entertainment platform. This module utilizes various technical aspects and options to refine the selection process and provide accurate and relevant recommendations.

In some embodiments, RCS Module 435 can be configured to select a subset of candidate recommendations based on normalized scores and weighted factors. It can consider the outputs from AI/ML models, contextual normalization, and user-specific profiles to curate recommendations that align with the user's preferences and interests. RCS Module 435 can integrate one or more of the following technical elements.

In some embodiments, RCS Module 435 leverages user profiles, which contain data elements inputted by the user, historical data, and interactions with the system. The profiles capture information such as username, birthdate, astrological sign, financial budget, geolocation, cultural makeup, travel preferences, pet and music interests, and food and drink preferences based on molecular structure. In some embodiments, RCS Module 435 integrates with AI/ML engines that generate predictions and insights based on the user profiles and historical data. These models continuously learn from the data to improve recommendation accuracy. In some embodiments, RCS Module 435 employs collaborative filtering techniques to compare user preferences and behaviors. It identifies similarities between users with similar profiles and recommends items that have been appealing to those users. This technique enhances the accuracy of the recommendations. In some embodiments, RCS Module 435 also utilizes content-based filtering to analyze the attributes and characteristics of items. It recommends similar items based on the user's preferences and interests, improving the relevance of the recommendations. In some embodiments, RCS Module 435 incorporates a normalization engine that normalizes the scores of candidate recommendations. This contextual normalization factor ensures that the recommendations can be balanced and aligned with the user's profile. In some embodiments, RCS Module 435 scores and weights the candidate recommendations against multiple AI/ML models. This approach enables a comprehensive evaluation of the recommendations, considering various factors and preferences. In some embodiments, RCS Module 435 can be part of a continuous feedback loop, which allows the system to learn and adapt over time. Feedback from user interactions and evolving user preferences can be incorporated into RCS Module 435, enhancing the accuracy and relevance of future recommendations. In some embodiments, RCS Module 435 can incorporate advanced recommendation algorithms, such as deep learning models, reinforcement learning, or hybrid models that combine different techniques. These algorithms can further improve the accuracy and personalization of the recommendations.

In some embodiments, RCS Module 435 can process user interactions and data in real-time, allowing for immediate updates to the recommendations. This ensures that the recommendations are always up-to-date and reflect the user's current preferences. In some embodiments, RCS Module 435 can employ hybrid approaches that combine collaborative filtering, content-based filtering, and other techniques to provide a diverse range of recommendations. This approach caters to different user preferences and enhances the recommendation quality. In some embodiments, RCS Module 435 can integrate external data sources, such as social media data, user reviews, or product databases, to enrich the recommendation process. This integration allows for a more comprehensive understanding of user preferences and improves the quality of the recommendations. In some embodiments, RCS Module 435 can consider contextual factors, such as the user's current location, time of day, or device used, to further refine the recommendations. This contextualization enhances the relevance and usefulness of the recommendations in specific situations.

In some embodiments, RCS Module 435 can provide explanations or insights about the reasons behind the recommendations. This transparency allows users to understand how the recommendations are generated and builds trust in the system. In some embodiments, RCS Module 435 can provide recommendations that go beyond traditional product recommendations. It can incorporate experiential recommendations, such as events, travel destinations, or personalized content playlists, to enhance the overall entertainment experience.

In a non-limiting example, RCS module 435 can employ Python programming language and utilize the scikit-learn library for efficient and effective recommendation candidate selection. By leveraging data from AI/ML models, contextual normalization factors, and user-specific profiles, the RCS module enables personalized and tailored recommendations. The RCS module plays a crucial role in recommendation systems by selecting a subset of candidate recommendations based on various factors, such as scores from AI/ML models, contextual normalization, and user-specific profiles. The following specification provides a detailed description of the RCS module implementation using Python and the scikit-learn library.

RCS module 435 can perform a step of installing necessary libraries. In some embodiments, RCS module 435 can install one or more libraries selected from (but not limited to) NumPy, scikit-learn, Pandas, PyTorch, TensorFlow, Keras, or the like. These libraries provide essential tools for data manipulation, numerical computation, and machine learning algorithms.

RCS module 435 can implement data preparation. The data utilized in this RCS module 435 module can include scores generated by AI/ML models, contextual normalization factors, and user-specific profiles. In some embodiments, preprocessing and structuring data in a suitable format can ensure compatibility with the RCS module.

Once the data is prepared, the RCS module can incorporate suitable normalization techniques to standardize the scores obtained from AI/ML models. Normalization ensures that scores from different models or sources are on a comparable scale, enabling fair and accurate comparison during the recommendation candidate selection process. The scikit-learn library provides various normalization methods, such as Min-Max scaling or Z-score normalization, which can be applied based on specific requirements.

After normalization, the RCS module can calculate weighted scores by considering user-specific profiles and the normalized scores. User-specific profiles capture individual preferences, demographics, or other relevant attributes that influence the recommendations. These profiles can be combined with the normalized scores to assign weights to different recommendation factors. The scikit-learn library offers powerful tools for numerical computation, allowing efficient calculation of weighted scores.

Based on the weighted scores and specific criteria, the RCS module can select the top recommendations to be presented to the user. This selection process involves ranking the recommendations according to the weighted scores and applying thresholding or other filtering techniques. The specific criteria for selecting the top recommendations may vary based on the application domain and user preferences.

The RCS module implementation using Python and scikit-learn offers several advantages. Firstly, Python provides a flexible and widely adopted programming language for data manipulation and algorithmic implementation. Additionally, the scikit-learn library offers a comprehensive collection of machine-learning algorithms, making it suitable for recommendation candidate selection tasks. The RCS module can be applied in various recommendation systems, including e-commerce platforms, content streaming services, and personalized marketing applications, to enhance the accuracy and relevance of recommendations provided to users.

RCS module using Python and the scikit-learn library incorporating data preparation, normalization, weighted scoring, and top recommendation selection steps to improve the accuracy and personalization of recommendations generated by recommendation systems. This implementation provides a flexible and efficient solution that can be integrated into various recommendation system architectures.

Personalization and Tailoring Module 440 customizes the recommendations and tailors them to the individual user. This module takes into account the user's profile, preferences, historical data, and real-time interactions to refine and personalize the recommendations. The personalized recommendations can be displayed to the user within the entertainment platform, enhancing the user experience and increasing engagement.

Continuous Feedback Loop 445 ensures that Recommendation System 400 evolves and improves over time. Feedback from user interactions, feedback loops, and changing user preferences can be incorporated into the system to enhance the accuracy and relevance of future recommendations. The continuous feedback loop facilitates learning and adaptation, resulting in a more personalized and effective recommendation system.

Recommendation System 400 can include a continuous feedback loop 445 mechanism to enhance the accuracy and relevance of future recommendations. The continuous feedback loop facilitates learning and adaptation, resulting in a more personalized and effective recommendation system. Feedback from user interactions, feedback loops, and changing user preferences can be incorporated into the system, enabling Recommendation System 400 to improve the quality of recommendations provided to users over time.

Recommendation systems play a vital role in enhancing user experiences by providing personalized recommendations for products, content, experiences, or services. However, user preferences and interests often change over time, necessitating a mechanism for the recommendation system to adapt and improve continuously. Existing systems often lack the capability to incorporate evolving user preferences into their recommendations effectively.

Continuous feedback loop mechanism addresses the limitations of conventional recommendation systems by allowing Recommendation System 400 to evolve and improve over time. By integrating user feedback, interactions, and preferences, the recommendation system ensures that the recommendations remain accurate and relevant, resulting in an enhanced user experience.

In one embodiment, Recommendation System 400 includes a continuous feedback loop, denoted as Continuous Feedback Loop 445. This loop enables the system to capture and incorporate feedback from user interactions and changing user preferences. By doing so, the system adapts to evolving user needs and provides more personalized recommendations.

Recommendation System 400 can collect data on user interactions, feedback loops, and user preferences. This data may include user ratings, explicit feedback, purchase history, browsing behavior, and other relevant information. The collected data can then be analyzed and processed using various techniques, including AI and ML algorithms. The analysis identifies patterns, trends, and changes in user preferences over time. Based on the analysis, the recommendation system learns and adapts its models and algorithms to incorporate the evolving user preferences. This adaptation can involve updating the AI/ML models, adjusting weights or parameters, or introducing new techniques to enhance the recommendation process. Updated models and algorithms can be applied to generate more accurate and relevant recommendations. The recommendations reflect the evolving user preferences, ensuring a personalized user experience.

Users can interact with the recommendation system, providing feedback on the recommendations received. This feedback can include ratings, reviews, likes, dislikes, or any other explicit or implicit form of user feedback. The user feedback can be collected and incorporated into the continuous feedback loop. The system utilizes this feedback to further refine the recommendation models and algorithms, making the recommendations even more personalized and aligned with user preferences.

The continuous feedback loop operates iteratively, ensuring a continuous improvement cycle for the recommendation system. As users provide feedback, the system learns, adapts, and generates updated recommendations, resulting in an ongoing evolution of the system's accuracy and relevance.

By incorporating the continuous feedback loop, Recommendation System 400 ensures that it remains up to date with evolving user preferences. The system leverages user feedback, interactions, and changing preferences to continually refine and enhance the recommendations. As a result, users benefit from a more personalized and effective recommendation system, improving their overall entertainment experience.

Scalable Architecture and Cloud Deployment 450 provide the foundation for Recommendation System 400. The system can be configured for scalability, utilizing cloud computing services to accommodate increasing user demands and optimize resource utilization. Auto-scaling, load balancing, and containerization technologies can be employed to ensure system performance, fault tolerance, and operation.

Runtime Services and Libraries 455 power the microservices within Recommendation System 400. These services facilitate inter-process and service communications, ensuring reliable and efficient communication between system components. They contribute to the resilience, fault tolerance, and overall robustness of the system. Specific technologies and frameworks for implementing these services can include, but are not limited to, RESTful APIs, message queues, or RPC frameworks like gRPC.

Data Persistence and Content Delivery 460 enable efficient storage and retrieval of large volumes of data. These features ensure smooth data operations and support the growth of the user base. Integration with Content Delivery Networks CDNs enhances content availability and global delivery, improving user experience across different regions. Storage options can include but are not limited to SQL (e.g., MySQL, PostgreSQL) or NoSQL (e.g., MongoDB, Cassandra) databases.

Technology Stack and Frameworks 465 encompass various technologies and frameworks utilized in Recommendation System 400. Examples include .NET, HTML, HTML Plus, Java, JavaScript, React, and Ionic. These technologies provide a solid foundation for implementing the system's functionalities, integrating with existing platforms, and ensuring compatibility with a wide range of devices.

In a non-limiting example, Recommendation System 400 can be implemented using AWS Cloud Computing Services. AWS services like Route 53, EC2, and S3 can be utilized for infrastructure setup, load balancing, and storage, respectively. The specific configuration and implementation details may vary based on the requirements and objectives of the system.

In operation, Recommendation System 400 captures user attributes through User Profile Management Module 410, collects and analyzes user data via Data Collection and Analysis Module 415, and employs AI/ML Engines 420 to generate personalized recommendations. The system utilizes collaborative filtering, content-based filtering, and RCS techniques to refine and tailor the recommendations. Continuous feedback and learning through the feedback loop contribute to the ongoing improvement and accuracy of the recommendations.

The scalable architecture, runtime services, data persistence, and cloud deployment ensure the efficient operation of Recommendation System 400, while the technology stack and frameworks provide a versatile and compatible platform for implementation. The system can enhance the user's entertainment experience by delivering highly curated recommendations and personalized interactions within the entertainment platform.

Recommendation System 400, as described herein, provides an advanced recommendation solution that enhances the user's entertainment experience. Through user profile management, data collection and analysis, AI/ML engines, collaborative and content-based filtering, personalized recommendations, and continuous feedback, the system generates accurate and tailored recommendations. The scalable architecture, runtime services, data persistence, and cloud deployment ensure operation and efficient resource utilization. By leveraging advanced technologies and frameworks, Recommendation System 400 delivers a highly curated and personalized user experience within the entertainment platform.

### Voice Control and Emotional Stimulation

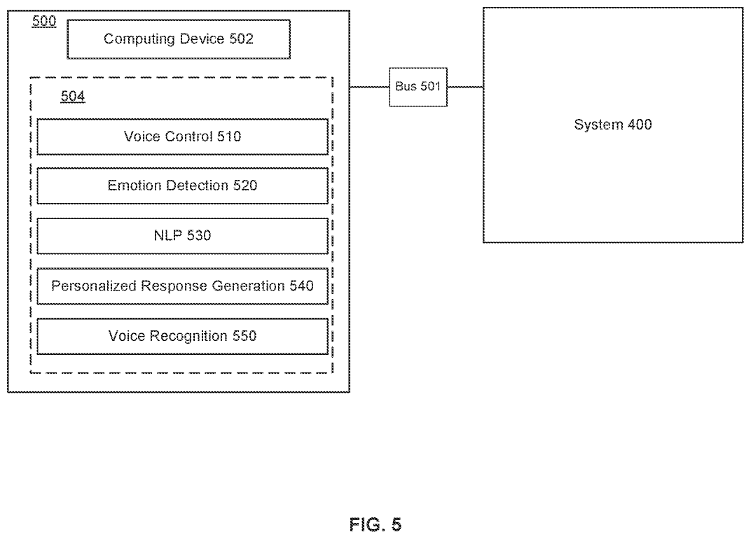

FIG. 5 illustrates another embodiment of a recommendation system, which can include one or more aspects described above. As shown in FIG. 5, an embodiment of the present disclosure can include a system, referred to as system 500, can be provided to enhance the user's entertainment experience by incorporating voice control capabilities and emotional stimulation into an entertainment platform. Building upon the features described in the earlier disclosure, system 500 can include one or more modules to implement functions and user experience. For example, system 500 can include one or more of Voice Control Module 510, Emotion Detection Module 520, Natural Language Processing (NLP) Module 530, Personalized Response Generation Module 540, Voice Recognition System 550,

The voice control module 510 enables users to interact with the entertainment platform using voice commands. It utilizes advanced natural language processing NLP techniques to accurately understand and interpret user input. By leveraging the capabilities of the NLP module mentioned earlier, the voice control module 510 allows users to perform actions such as purchasing products, adding items to their cart or wish list, and requesting information about products or recommendations.

The emotion detection module 520 analyzes vocal characteristics, including tone, pitch, and other parameters, to detect the user's emotions during interactions with the platform. This module can enhance the personalized response generation module by adapting the system's tone, language, and content based on the user's detected emotions. By incorporating emotional stimulation, system 500 creates a more immersive and engaging user experience.

The NLP module 530, mentioned in the earlier disclosure, can employ techniques such as named entity recognition, sentiment analysis, and language modeling to accurately interpret user commands. By understanding the context and nuances of user input, the NLP module 530 enables system 500 to determine the user's intent and provide relevant responses. This module works in conjunction with the voice control module 510 to process voice commands and extract meaningful information.

The personalized response generation module 540 dynamically adapts the system's responses based on the user's detected emotions and preferences. Leveraging AI algorithms, this module can generate personalized responses aligned with the user's emotional state. As described in the earlier disclosure, the personalized response generation module 540 considers factors such as user preferences, historical data, and content metadata to provide tailored and emotionally resonant responses.

The voice recognition system 550 enables system 500 to accurately capture and analyze voice commands. It converts the user's voice input into text for further processing by the voice control module 510, emotion detection module 520, and NLP module 530. The voice recognition system 550 can be implemented using cloud-based voice recognition services or on-device speech recognition technologies, as mentioned in the earlier disclosure.

In conjunction with the previously disclosed elements, system 500 offers an enhanced entertainment platform experience. For example, utilizing the voice control module 510, users can initiate purchases by voicing commands such as “Buy this whiskey” or “Add this to my cart.” The system processes these commands, confirms the user's intent, and completes the purchase.

The integration of the emotion detection module 520 allows system 500 to understand the user's emotional state during interactions. This information can enhance the personalized response generation module 540, enabling the system to adapt its tone, language, and content to align with the user's emotions. For instance, when a user expresses excitement or satisfaction, the system can respond with corresponding enthusiasm, creating a more engaging and emotionally resonant experience.

The NLP module 530 can be configured to accurately interpret user commands and understanding the context of user input. It assists the voice control module 510 in processing voice commands, extracting relevant information, and performing actions based on the user's intent. This integration between the voice control module 510 and the NLP module 530 enhances the overall usability and intuitiveness of system 500.

Moreover, the voice recognition system 550 ensures accurate capture and analysis of voice commands, facilitating the functioning of the voice control module 510, emotion detection module 520, and NLP module 530. By accurately converting voice input into text, the system maintains a high level of accuracy in interpreting user commands and generating appropriate responses.

In conclusion, system 500 integrates the voice control module 510, emotion detection module 520, NLP module 530, personalized response generation module 540, and voice recognition system 550 to deliver an enhanced entertainment platform experience. These structural and modular elements, in conjunction with the features described in the earlier disclosure, enable intuitive voice-controlled interactions, personalized responses, and emotional stimulation. In a non-limiting example, through the integration of these components, system 500 enhances the way users interact with the entertainment platform, creating a more immersive and engaging user experience.

System 200 can integrate voice control module 210, emotion detection module 220, NLP module 230, personalized response generation module 240, and voice recognition system 250 to deliver an enhanced entertainment platform experience. These structural and modular elements, in conjunction with the features described in the earlier disclosure, enable intuitive voice-controlled interactions, personalized responses, and emotional stimulation. Through the integration of these components, system 200 enhances the way users interact with the entertainment platform, creating a more immersive and engaging user experience.

System 500 can be an embodiment of one or more systems described above. For example, system 500 can be an embodiment of system 400. In one non-limiting example, the integration of voice control capabilities and emotional stimulation into system 400 can be achieved by integrating components and modules to enhances the user's entertainment experience by enabling voice-controlled interactions, personalized responses, and emotional stimulation within the entertainment platform.

In one non-limiting example, voice control module 510 can be integrated into the existing architecture of system 400. This integration can include operably connecting the voice control module 510 with the other modules, such as the user profile management module 510, data collection and analysis module 415, and recommendation candidate selection module 435. This integration allows users to interact with the system using voice commands for actions such as product purchases, adding items to their cart or wish list, and requesting information.

The emotion detection module 520 can be incorporated into the system's architecture to analyze vocal characteristics and detect the user's emotions during interactions. This integration enhances the personalized response generation module 540 by adapting the system's tone, language, and content based on the user's detected emotions. The emotion detection module 520 can interact with the voice control module 510 and other modules to provide emotionally resonant responses, creating a more immersive and engaging user experience.

The NLP module 530 can be configured to accurately interpret user commands and understanding the context of user input. It works in conjunction with the voice control module 510 to process voice commands, extract meaningful information, and determine the user's intent. The NLP module 530 enhances the voice control capabilities of system 500, allowing users to interact with the platform using natural language and receiving relevant responses.

The personalized response generation module 540 can dynamically adapt the system's responses based on the user's detected emotions and preferences. Leveraging AI algorithms and integrating with emotion detection module 520, system 500 can generate personalized and emotionally resonant responses aligned with the user's emotional state. The system can be configured to consider factors such as user preferences, historical data, and content metadata to tailor the responses and enhance the overall user experience.

Voice recognition system 550 can be implemented to accurately capture and analyze voice commands within system 500. It converts the user's voice input into text, which can be processed by the voice control module 510, emotion detection module 520, and NLP module 530. The voice recognition system 550 can utilize cloud-based voice recognition services or on-device speech recognition technologies to ensure accurate and efficient voice command processing.

System 500 can incorporate the voice control module 510, emotion detection module 520, NLP module 530, personalized response generation module 540, and voice recognition system 550 into the existing architecture of system 400. Through the integration of these elements, system 500 enhances the user's entertainment experience by providing intuitive voice-controlled interactions, personalized responses, and emotional stimulation within the entertainment platform.

### Disposition Recognition

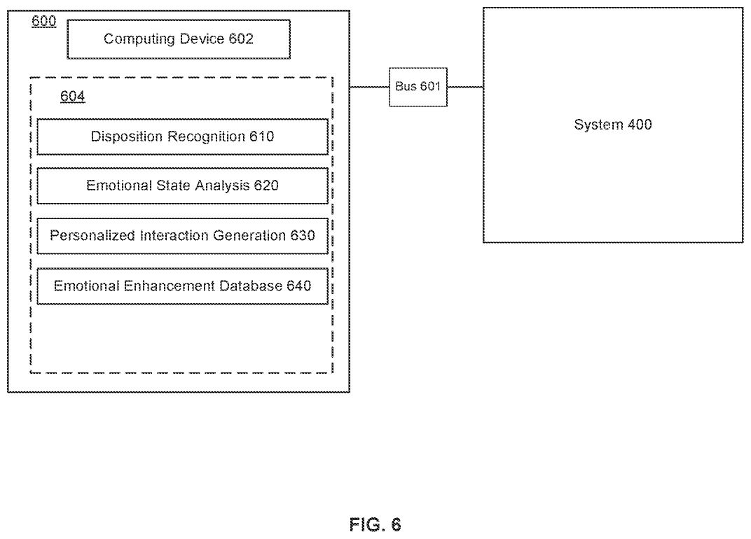

FIG. 6 illustrates another embodiment of a recommendation system, which can include one or more aspects described above. As shown in FIG. 6, an embodiment can include system 600 configured to perform disposition recognition, utilizing voice analysis to determine a user's emotional state and offering pre-programmed interactions to help improve their mood. System 600 can include one or more modules configured to enhance the user's entertainment experience by providing personalized responses and tailored recommendations based on the detected emotional state, such that system 600 can be enabled to analyze the user's emotional state, interpret the data, and generate appropriate responses. In some non-limiting examples, system 600 can include one or more modules selected from Disposition Recognition Module 610, Emotional State Analysis Module 620, Personalized Interaction Generation Module 630, and Emotional Enhancement Database 640.

Disposition Recognition Module 610 can be configured to recognize the user's emotional state based on voice analysis. By analyzing vocal characteristics, including tone, pitch, and other parameters, this module can determine the user's emotional disposition during interactions with the entertainment platform. The Disposition Recognition Module 610 employs advanced algorithms and machine learning techniques to accurately interpret the emotional cues present in the user's voice.

Emotional State Analysis Module 620 processes the data obtained from the Disposition Recognition Module 610 and performs a comprehensive analysis of the user's emotional state. This module can consider various factors, such as voice patterns, speech content, and intonation, to derive insights into the user's emotions. Through the application of AI and machine learning algorithms, the Emotional State Analysis Module 620 continuously improves its accuracy in recognizing and understanding the user's emotional disposition.

Personalized Interaction Generation Module 630 utilizes the emotional data from the Emotional State Analysis Module 620 to generate personalized responses and interactions. This module leverages a database of pre-programmed interactions tailored to different emotional states. By matching the user's emotional state with the corresponding pre-programmed interactions, the Personalized Interaction Generation Module 630, which can be an embodiment of personalized response generation module 540, provides responses that can be designed to uplift the user's mood, engage them in a positive manner, or offer support based on their emotional needs.

Emotional Enhancement Database 640 stores a collection of pre-programmed interactions and responses categorized according to different emotional states. These interactions can be carefully designed to address the user's emotional needs and improve their mood. The Emotional Enhancement Database 640 can be continuously updated and expanded to include a wide range of emotional states and corresponding interactions.

By combining these modular elements, system 600 provides an immersive and emotionally resonant entertainment experience. As the user interacts with the platform, the Disposition Recognition Module 610 analyzes their voice, the Emotional State Analysis Module 620 interprets their emotional disposition, and the Personalized Interaction Generation Module 630 generates appropriate responses. This integration allows the system to respond to the user's emotional needs, offer support, and enhance their overall mood during the entertainment experience.

To implement system 600 into the existing architecture of system 400, one or more steps can be taken. In one non-limiting example, the following modifications and additions can be made:

Integration of the Disposition Recognition Module 610: The Disposition Recognition Module 610 can be integrated into the existing system architecture as a new module. It will receive the user's voice input and perform voice analysis to determine their emotional state. This module will work in conjunction with the other modules of system 400 to enhance the recommendation generation process and personalize the user's entertainment experience based on their emotional disposition.

Integration of the Emotional State Analysis Module 620: The Emotional State Analysis Module 620 can be added to the system architecture to process the emotional data obtained from the Disposition Recognition Module 610. It will analyze the emotional cues present in the user's voice and derive insights into their emotional state. This module will work in tandem with the existing AI/ML Engines 420 and Data Collection and Analysis Module 415 to further refine the recommendations and tailor the system's responses based on the user's emotional disposition.

Personalized Interaction Generation Module 630 can be integrated into the system architecture to generate personalized responses and interactions based on the user's emotional state. This module will utilize the emotional data obtained from the Emotional State Analysis Module 620 to match the user's emotional disposition with the corresponding pre-programmed interactions stored in the Emotional Enhancement Database 640. The module will work alongside the Recommendation Candidate Selection Module 435 and Personalization and Tailoring Module 440 to deliver emotionally resonant recommendations and interactions.

Emotional Enhancement Database 640 can be added to the system architecture to store the collection of pre-programmed interactions categorized according to different emotional states. This database will provide the Personalized Interaction Generation Module 630 with the necessary resources to generate appropriate responses based on the user's emotional needs. The Emotional Enhancement Database 640 can be continuously updated and expanded to enrich the range of interactions available for different emotional states.

By integrating these elements into the existing architecture of system 400, system 600 enhances the entertainment experience by recognizing the user's emotional state and providing personalized interactions and responses. The Disposition Recognition Module 610, Emotional State Analysis Module 620, Personalized Interaction Generation Module 630, and Emotional Enhancement Database 640 work together to create a more engaging, supportive, and emotionally resonant entertainment platform.

System 600, in an embodiment, can be configured to perform disposition recognition in an entertainment platform. By analyzing the user's voice, determining their emotional state, and generating pre-programmed interactions tailored to their emotional disposition, system 600 enhances the entertainment experience by offering personalized responses and emotional support. The integration of the Disposition Recognition Module 610, Emotional State Analysis Module 620, Personalized Interaction Generation Module 630, and Emotional Enhancement Database 640 into the existing architecture of system 400 enables the system to detect and respond to a user's specific disposition.

### Dynamic Content Aggregation and Cross-Provider Integration

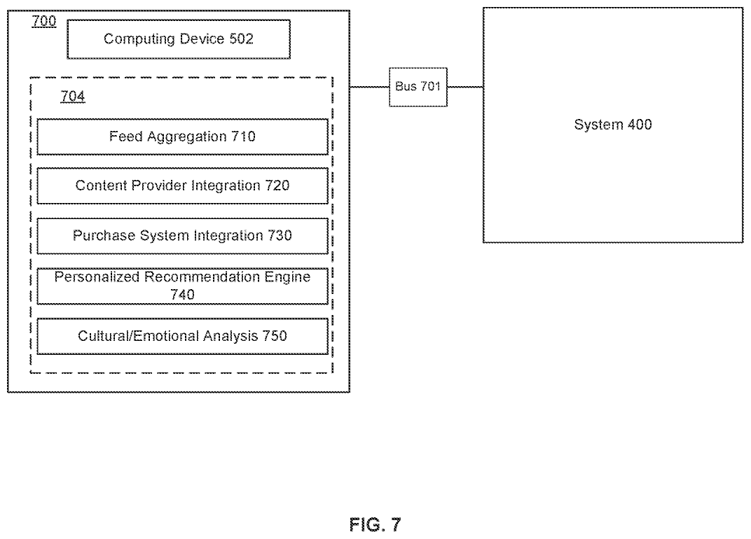

FIG. 7 illustrates another embodiment of a recommendation system, which can include one or more aspects described above. As shown in FIG. 7, an embodiment can include system, 700 can be configured to enhance user entertainment experience by incorporating dynamic content aggregation and cross-provider integration in a personalized recommendation system, such as architecture of system 400.

System 700 can include one or more modules configured to provide multiple entertainment sources and to consider the user's viewing and purchasing history, as well as their cultural background and emotional reactions to provide personalized and diverse content recommendations. In some non-limiting examples, system 700 can include one or more modules selected from Feed Aggregation Module 710, Content Provider Integration 720, Purchase System Integration 730, Personalized Recommendation Engine 740, and Cultural Background and Emotional Reactions Analysis 750. System 700 can be configured to enable users to access feeds from multiple content providers, transact with them through the purchase system, and offers a wide variety of options for viewers to choose from.

The Feed Aggregation Module 710 can be configured to enable users to access feeds from multiple content providers within the entertainment platform. This module integrates with the existing modules such as the user profile management module 410, data collection and analysis module 415, and recommendation candidate selection module 435. It allows users to choose from a wide variety of content options and switch between different screens or feeds.

The content provider integration component 720 can be configured to integrate feeds from multiple content providers into the system. This integration allows the platform to offer a diverse range of content options, such as movies, TV shows, live streams, music, and more. The integration process involves establishing partnerships with content providers, setting up APIs or data exchange mechanisms, and ensuring smooth content delivery and synchronization across multiple screens or feeds.

The purchase system integration component 730 facilitates transactions with multiple content providers through the platform's purchase system. It allows users to make purchases, such as renting or buying movies, subscribing to streaming services, or purchasing digital content, directly within the entertainment platform. This integration involves establishing secure payment gateways, ensuring communication between the platform and content providers' systems, and providing a unified purchasing experience for the users.

The personalized recommendation engine 740 in system 700 can be configured to consider the user's viewing and purchasing history, as well as their cultural background and emotional reactions, to generate personalized content recommendations. This engine leverages the data collected and analyzed by the data collection and analysis module 415, user profile management module 410, and recommendation candidate selection module 435 to provide tailored recommendations across multiple screens or feeds. It considers factors such as the user's preferences, content consumption patterns, previous purchases, and emotional responses to enhance the relevance and personalization of the recommendations.

The cultural background and emotional reactions analysis component 750 can be integrated into the system to consider the user's cultural background and emotional responses when providing content recommendations. This component employs advanced techniques, such as sentiment analysis and cultural profiling, to understand the user's emotional reactions to different content types and their cultural preferences. By analyzing these factors, the system can offer content that aligns with the user's cultural background and emotional preferences, enhancing the overall entertainment experience.

In one non-limiting example, system 700 can be configured to enhance user entertainment experience by incorporating multi-screen/multi-feed capabilities into the existing architecture of a recommendation system, for example, system 400. This integration can include operably connecting Feed Aggregation Module 710, content provider integration 720, purchase system integration 730, personalized recommendation engine 740, and cultural background and emotional reactions analysis 750 can be integrated with the previously described modules.

The Feed Aggregation Module 710 can be integrated with the user profile management module 410 and data collection and analysis module 415 to capture and analyze the user's preferences, viewing history, and emotional responses across different screens or feeds. This integration allows the system to offer personalized content recommendations based on the user's interactions with multiple content providers.

Content provider integration 720 component establishes connections with various content providers, enabling the platform to access feeds from multiple sources. This integration ensures content delivery and synchronization across different screens or feeds, providing users with a diverse range of options to choose from.

Purchase system integration 730 component can integrate the platform's purchase system with the systems of multiple content providers. This integration allows users to transact with different content providers directly within the entertainment platform, streamlining the purchasing process and providing a unified experience for users.

Personalized recommendation engine 740 incorporates the data collected by the data collection and analysis module 415, user profile management module 410, and recommendation candidate selection module 435. This integration enables the engine to generate personalized content recommendations based on the user's viewing and purchasing history across multiple screens or feeds.

Cultural background and emotional reactions analysis 750 component analyzes the user's cultural background and emotional responses to different content types. This analysis can be integrated with the personalized recommendation engine 740 to provide content recommendations that align with the user's cultural preferences and emotional reactions, enhancing the relevance and personalization of the recommendations.

By integrating the multi-screen/multi-feed capabilities and related components into the existing architecture of system 400, system 700 can provide an enhanced entertainment platform experience. Users can access feeds from multiple content providers, transact through the purchase system, and enjoy a wide variety of content options personalized to their preferences, viewing history, cultural background, and emotional reactions. This integration expands the platform's content offerings, enhances personalization, and provides users with a more diverse and engaging entertainment experience.

### Augmented Reality and Enhanced Sensory Integration

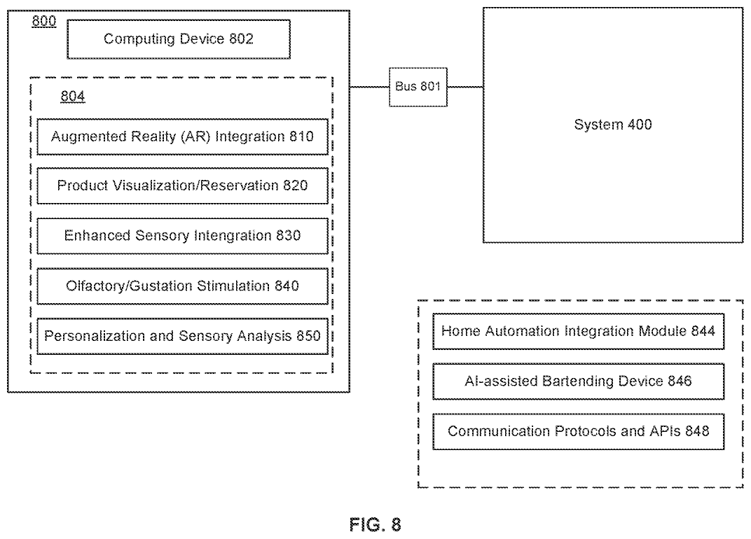

FIG. 8 illustrates another embodiment of a recommendation system, which can include one or more aspects described above. As shown in FIG. 8, an embodiment can include system 800 can be configured to integrate augmented reality (AR) and enhanced sensory experiences into the existing architecture of system 400. This embodiment can enhance the gaming and entertainment industry by enabling users to interact with the platform using AR technology and incorporating additional sensory elements, such as olfactory and gustatory stimuli. System 800 can include one or more modules configured to leverage advanced integration techniques and personalized data analysis, such that system 800 can be enabled to create an immersive and personalized user experience. In some non-limiting examples, system 800 can include one or more modules selected from AR Integration Module 810, Product Visualization and Reservation Engine 820, Enhanced Sensory Integration Framework 830, Olfactory and Gustatory Stimulation Module 840, and Personalization and Sensory Preference Analysis Module 850.

The augmented reality integration module 810 integrates AR technology into the entertainment platform, allowing users to overlay virtual objects and information onto their real-world environment. By leveraging computer vision algorithms, motion tracking, and spatial mapping techniques, the module accurately aligns virtual content with the user's physical surroundings, creating a and immersive AR experience.

Product visualization and reservation engine 820 enables users to make real-time purchases or book reservations based on AR-enabled product visualizations. By integrating with e-commerce APIs and location-based services, this engine identifies virtual objects in the user's environment and provides real-time product information, pricing, and availability. Users can interact with virtual representations of products, place orders, and make reservations directly through the AR interface.

System 800 can be configured to include enhancements outside the realm of visual enhancements and to integrate of additional sensory modalities to create a fully immersive experience. The enhanced sensory integration framework 830 can be configured to incorporate olfactory and gustatory stimuli into the user's interaction with the platform. By analyzing user profiles, preferences, and contextual data, this framework adapts sensory experiences to provide a personalized and engaging user journey.

The olfactory and gustatory stimulation module 840 can be configured to deliver scent and taste experiences to users through specialized hardware and algorithms. Utilizing scent emitters and taste simulators, this module precisely emits scents and creates taste sensations that align with the virtual content and the user's interactions. By synchronizing sensory cues with the AR environment, the module enhances immersion and creates a more realistic and engaging user experience.

The personalization and sensory preference analysis module 850 utilizes advanced data analytics techniques to understand and cater to individual user preferences for sensory experiences. By analyzing user profiles, historical interactions, and contextual data, this module generates personalized scent and taste profiles, ensuring that the delivered sensory cues align with each user's preferences and maximize engagement.

System 800 can be an embodiment of one or more systems described in this disclosure. In one non-limiting example, system 800 can be an embodiment of system 400. For example, in some embodiments, augmented reality integration module 810 should be integrated with the existing modules such as the user profile management module 410 and the recommendation candidate selection module 435. This integration enables the real-time overlay of virtual objects and information onto the user's real-world environment, enhancing the overall user experience and engagement.

The product visualization and reservation engine 820 requires integration with e-commerce platforms, location-based services, and databases to retrieve real-time product information, pricing, and availability. APIs and data exchange protocols should be implemented to ensure communication between the engine and external systems, enabling users to make purchases and reservations directly through the AR interface.

The olfactory and gustatory stimulation module 840 involves the integration of specialized scent emitters and taste simulators into the system architecture. The hardware components should be connected to the AR platform, allowing synchronized delivery of scents and taste sensations in conjunction with the virtual content. Calibration and control mechanisms should be established to ensure accurate and consistent sensory experiences.

The personalization and sensory preference analysis module 850 should be integrated with the existing user profile management module 410 and data collection and analysis module 415. This integration allows for the analysis of user preferences, historical data, and contextual information to generate personalized scent and taste profiles. Continuous feedback loops and machine learning algorithms can be employed to refine and enhance the personalization capabilities over time.

By implementing the above technical aspects, system 800 integrates augmented reality and enhanced sensory experiences into the existing architecture of system 400. This integration allows users to enjoy immersive gaming experiences, visualize products in their real-world environment, and engage their senses through scent and taste, all tailored to their preferences and interests.

In some embodiments, system 800 can be configured to integrate augmented reality (AR) and enhanced sensory experiences into the existing architecture of system 400. This embodiment can enhance the gaming and entertainment industry by enabling users to interact with the platform using AR technology and incorporating additional sensory elements, such as olfactory and gustatory stimuli. System 800 can include one or more modules configured to leverage advanced integration techniques and personalized data analysis, such that system 800 can be enabled to create an immersive and personalized user experience. In some non-limiting examples, system 800 can include one or more modules selected from Augmented Reality Integration Module 810, Product Visualization and Reservation Engine 820, Enhanced Sensory Integration Framework 830, Olfactory and Gustatory Stimulation Module 840, and Personalization and Sensory Preference Analysis Module 850.

The augmented reality integration module 810 integrates AR technology into the entertainment platform, allowing users to overlay virtual objects and information onto their real-world environment. By leveraging computer vision algorithms, motion tracking, and spatial mapping techniques, the module accurately aligns virtual content with the user's physical surroundings, creating an immersive AR experience. This integration can be achieved by utilizing AR development platforms such as Unity or Unreal Engine, which provide tools and libraries for creating AR applications. The module can access camera feeds, perform real-time object tracking and recognition, and render virtual objects in the user's field of view, providing an AR experience.

Product visualization and reservation engine 820 enables users to make real-time purchases or book reservations based on AR-enabled product visualizations. By integrating with e-commerce APIs and location-based services, this engine identifies virtual objects in the user's environment and provides real-time product information, pricing, and availability. Users can interact with virtual representations of products, place orders, and make reservations directly through the AR interface. This integration can involve connecting to e-commerce platforms such as Shopify, Magento, or WooCommerce, retrieving product data through APIs, and facilitating secure transactions using payment gateways. Location-based services like Google Maps or GPS systems can provide geolocation information for accurate product visualization and localized purchasing options.

System 800 can be configured to include enhancements outside the realm of visual enhancements and to integrate additional sensory modalities to create a fully immersive experience. The enhanced sensory integration framework 830 can be configured to incorporate olfactory and gustatory stimuli into the user's interaction with the platform. By analyzing user profiles, preferences, and contextual data, this framework adapts sensory experiences to provide a personalized and engaging user journey. The framework can leverage technologies such as Internet of Things (IoT) devices, scent-emitting devices, and taste simulators to deliver olfactory and gustatory cues aligned with the virtual content. These devices can be connected to the platform through wireless communication protocols such as Bluetooth or Wi-Fi, enabling synchronized sensory experiences.

The olfactory and gustatory stimulation module 840 can be configured to deliver scent and taste experiences to users through specialized hardware and algorithms. Utilizing scent emitters and taste simulators, this module precisely emits scents and creates taste sensations that align with the virtual content and the user's interactions. By synchronizing sensory cues with the AR environment, the module enhances immersion and creates a more realistic and engaging user experience. The integration of scent-emitting devices, such as fragrance diffusers or atomizers, and taste simulators, such as electric taste stimulators, can be achieved by establishing communication protocols between the module and the hardware devices. These devices can be controlled and activated based on the virtual content and user interactions, creating synchronized olfactory and gustatory experiences.

The personalization and sensory preference analysis module 850 utilizes advanced data analytics techniques to understand and cater to individual user preferences for sensory experiences. By analyzing user profiles, historical interactions, and contextual data, this module generates personalized scent and taste profiles, ensuring that the delivered sensory cues align with each user's preferences and maximize engagement. This module can employ machine learning algorithms, such as collaborative filtering or content-based filtering, to extract patterns and preferences from user data. The module can continuously learn and adapt based on user feedback and interactions, refining the personalized sensory experiences over time.

In the implementation of system 800 into the existing architecture of system 400, several technical aspects need to be considered. For example, augmented reality integration module 810 should be integrated with the existing modules such as the user profile management module 410 and the recommendation candidate selection module 435. This integration enables the real-time overlay of virtual objects and information onto the user's real-world environment, enhancing the overall user experience and engagement. The integration can be achieved by establishing communication channels between the modules, allowing the exchange of data and information required for AR rendering and content selection.

The product visualization and reservation engine 820 requires integration with e-commerce platforms, location-based services, and databases to retrieve real-time product information, pricing, and availability. APIs and data exchange protocols should be implemented to ensure communication between the engine and external systems, enabling users to make purchases and reservations directly through the AR interface. This integration involves integrating with e-commerce platforms' APIs, establishing secure communication channels for data exchange, and implementing database connectivity for real-time product updates and availability.

The olfactory and gustatory stimulation module 840 involves the integration of specialized scent emitters and taste simulators into the system architecture. The hardware components should be connected to the AR platform, allowing synchronized delivery of scents and taste sensations in conjunction with the virtual content. Calibration and control mechanisms should be established to ensure accurate and consistent sensory experiences. This integration requires the development of communication protocols and drivers to interface with the hardware devices, as well as synchronization mechanisms to align sensory cues with the AR content.

The personalization and sensory preference analysis module 850 should be integrated with the existing user profile management module 410 and data collection and analysis module 415. This integration allows for the analysis of user preferences, historical data, and contextual information to generate personalized scent and taste profiles. Continuous feedback loops and machine learning algorithms can be employed to refine and enhance the personalization capabilities over time. The integration involves data exchange and synchronization between the modules, enabling the flow of user data and preferences for personalized sensory experiences.

In this exemplary implementation, system 800 integrates augmented reality and enhanced sensory experiences into the existing architecture of system 400. This integration allows users to enjoy immersive gaming experiences, visualize products in their real-world environment, and engage their senses through scent and taste, all tailored to their preferences and interests. The utilization of technologies such as AR development platforms, e-commerce APIs, IoT devices, scent-emitting devices, and taste simulators enables the realization of system 800's goals, creating a truly immersive and personalized entertainment platform experience.

In some embodiments, system 800 can be configured to incorporate a sophisticated emotion detection and home automation system into the existing architecture of system 400. This embodiment can create personalized user experience by leveraging advanced technologies and automation processes. System 800 can include one or more additional modules designed to detect the user's emotional disposition and utilize a mechanical/AI system to prepare a favorite spirit or cocktail in accordance with the user's preferences when they arrive home. For example, personalization and sensory preference analysis module 850 can integrate with Disposition Recognition Module 610. Olfactory and Gustatory Stimulation Module 840 can include one or more additional modules such as Home Automation Integration Module 844, AI-assisted Device 846, and Communication Protocols and APIs 848.

In one non-limiting example, Disposition Recognition Module 610 can utilize advanced voice analysis techniques, including speech recognition, natural language processing, and emotion recognition algorithms. These technologies can be implemented using platforms such as Google Cloud Speech-to-Text API, which provides accurate speech recognition, and sentiment analysis algorithms, such as Microsoft Azure Text Analytics API, which can determine the emotional disposition based on vocal characteristics. By processing the user's voice input, the module can identify and analyze various acoustic features, including tone, pitch, energy, and rhythm, to infer the user's emotional state.

Home Automation Integration Module 844 can enable communication between system 800 and various home automation devices or systems. This module can leverage IoT platforms such as Amazon Web Services (AWS) IoT Core or Google Cloud IoT Core to connect and control smart home devices. It can utilize protocols like MQTT or CoAP for machine-to-machine communication. Additionally, APIs like Samsung SmartThings or Apple HomeKit can be used to interface with specific smart home ecosystems. By integrating with these technologies, the module can establish a secure and reliable connection with the user's home automation system.

AI-assisted Device 846 can be configured to prepare a sensory experience (e.g., a food, a cocktails or other spirit, etc.) with precision and automation. This device can be equipped with a range of features, including an automated liquor dispenser, mixing mechanisms, and recipe databases. A suitable platform for this device could be Arduino, a popular open-source electronics platform, which provides a flexible and programmable framework for controlling robotic systems. Additionally, machine learning algorithms, such as deep neural networks, can be employed to enhance the device's ability to understand and execute complex mixology techniques.

Communication Protocols and APIs 848 can facilitate communication between the Home Automation Integration Module 844 and the AI-assisted Bartending Device 846. MQTT (Message Queuing Telemetry Transport) can be employed as a lightweight and efficient messaging protocol to transmit commands and data between the modules. Additionally, RESTful APIs (Representational State Transfer) can be utilized to enable data exchange and interaction between the modules and external systems. These APIs can leverage standard communication protocols like HTTP and JSON to ensure interoperability and ease of integration.

In operation, when a user arrives home, Disposition Recognition Module 610 analyzes the user's vocal characteristics to detect their emotional disposition. The module utilizes voice recognition platforms like Google Cloud Speech-to-Text API to convert the user's speech into text, and sentiment analysis algorithms like Microsoft Azure Text Analytics API to determine the emotional state. By integrating these technologies, system 800 can accurately infer emotions such as happiness, stress, or relaxation based on acoustic features and linguistic patterns.

Upon detecting the user's emotional disposition, the Home Automation Integration Module 844 can be triggered to communicate with the AI-assisted Device 846. Using protocols like MQTT, the module transmits commands and instructions to the device (for example, an AI-assisted bartending device), specifying the desired spirit or cocktail to be prepared. The AI-assisted Device 846, powered by Arduino and equipped with recipe databases, executes the necessary mixing and dispensing actions with precision and efficiency.

System 800 can utilize Communication Protocols and APIs 848 to integrate various modules. RESTful APIs enable the Home Automation Integration Module 844 to exchange data and commands with the AI-assisted Device 846, ensuring a smooth flow of information and control. The protocols and APIs employed in this integration provide a standardized and interoperable framework for efficient communication between the modules and external systems.

In some embodiments, system 800 can detect the user's emotional disposition using advanced voice analysis techniques and subsequently trigger a sophisticated home automation system. The integration of platforms such as Google Cloud Speech-to-Text API, Microsoft Azure Text Analytics API, Arduino, MQTT, and RESTful APIs enables the communication and automation required to prepare a favorite spirit or cocktail in accordance with the user's preferences. This advanced embodiment enhances the user experience by providing a personalized, automated, and immersive interaction within the entertainment platform.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

In one general aspect, system may include a voice control module configured to enable user interaction with an entertainment platform using voice commands. System may also include an emotion detection module configured to analyze vocal characteristics of the user during interactions with the entertainment platform. System may furthermore include a natural language processing (NLP) module configured to interpret user commands within the context of the entertainment platform. System may in addition include a personalized response generation module configured to generate personalized responses within the entertainment platform based on the user's detected emotions and preferences. System may moreover include a voice recognition system configured to capture and analyze voice commands within the entertainment platform. Other embodiments of this aspect include corresponding computer systems, apparatus, and computer programs recorded on one or more computer storage devices, each configured to perform the actions of the methods.

Implementations may include one or more of the following features. System may include an user profile management module configured to capture and store user attributes to create personalized profiles. System may include a data collection and analysis module configured to collect and analyze user behavior, preferences, and historical data. System may include one or more artificial intelligence and/or machine learning (AI/ML) engines configured to generate accurate and personalized recommendations based on the collected data. System may include a content metadata and tagging module configured to associate metadata and tags with media content items. System may include a collaborative filtering and content-based filtering module configured to generate accurate and relevant recommendations based on user preferences and behaviors. System may include a recommendation candidate selection module configured to select a subset of candidate recommendations based on normalized scores and weighted factors. System may include a personalization and tailoring module configured to customize the recommendations based on the user's profile, preferences, and real-time interactions. System may include a continuous feedback loop to incorporate user feedback and evolving user preferences into the recommendation system. System may include a scalable architecture and cloud deployment to ensure system performance and accommodate increasing user demands. Implementations of the described techniques may include hardware, a method or process, or a computer tangible medium.

In one general aspect, method may include enabling user interaction with an entertainment platform using voice commands. Method may also include analyzing vocal characteristics to detect the user's emotions during interactions with the entertainment platform. Method may furthermore include interpreting user commands and understanding the context of user input. Method may in addition include generating personalized responses based on the user's detected emotions and preferences. Method may moreover include capturing and analyzing voice commands. Other embodiments of this aspect include corresponding computer systems, apparatus, and computer programs recorded on one or more computer storage devices, each configured to perform the actions of the methods.

Implementations may include one or more of the following features. Method may include capturing and storing user attributes to create personalized profiles. Method may include collecting and analyzing user behavior, preferences, and historical data. Method may include generating accurate and personalized recommendations based on the collected data. Method may include associating metadata and tags with media content items. Implementations of the described techniques may include hardware, a method or process, or a computer tangible medium.

In one general aspect, device may include a voice control module configured to enable user interaction with an entertainment platform using voice commands. Device may also include an emotion detection module configured to analyze vocal characteristics to detect the user's emotions during interactions with the entertainment platform. Device may furthermore include a natural language processing (NLP) module configured to interpret user commands and understand the context of user input. Device may in addition include a personalized response generation module configured to generate personalized responses based on the user's detected emotions and preferences. Device may moreover include a voice recognition system configured to capture and analyze voice commands. Other embodiments of this aspect include corresponding computer systems, apparatus, and computer programs recorded on one or more computer storage devices, each configured to perform the actions of the methods.

Implementations may include one or more of the following features. Device may include an user profile management module configured to capture and store user attributes to create personalized profiles. Device may include a data collection and analysis module configured to collect and analyze user behavior, preferences, and historical data. Device may include one or more artificial intelligence and/or machine learning (AI/ML) engines configured to generate accurate and personalized recommendations based on the collected data. Device may include a content metadata and tagging module configured to associate metadata and tags with media content items. Implementations of the described techniques may include hardware, a method or process, or a computer tangible medium.

In one general aspect, system may include a feed aggregation module configured to enable user access to feeds from multiple content providers within an entertainment platform. System may also include a content provider integration component configured to integrate feeds from multiple content providers into the system. System may furthermore include a purchase system integration component configured to facilitate transactions with multiple content providers through the entertainment platform's purchase system. System may in addition include a personalized recommendation engine configured to generate personalized content recommendations based on the user's viewing and purchasing history, cultural background, and emotional reactions. System may moreover include a cultural background and emotional reactions analysis component configured to consider the user's cultural background and emotional responses when providing content recommendations. Other embodiments of this aspect include corresponding computer systems, apparatus, and computer programs recorded on one or more computer storage devices, each configured to perform the actions of the methods.

Implementations may include one or more of the following features. System may include an user profile management module configured to capture and store user preferences, viewing history, and emotional responses. System may include a data collection and analysis module configured to collect and analyze user behavior, preferences, viewing history, and emotional responses. System may include one or more artificial intelligence and/or machine learning (AI/ML) engines configured to generate accurate and personalized recommendations based on the collected data. System may include a recommendation candidate selection module configured to select a subset of candidate recommendations based on normalized scores and weighted factors. System may include a personalization and tailoring module configured to customize the recommendations based on the user's profile, preferences, and real-time interactions. System may include a continuous feedback loop to incorporate user feedback and evolving user preferences into the recommendation system. System may include a scalable architecture and cloud deployment to ensure system performance and accommodate increasing user demands. System may include an interface for users to access feeds from multiple content providers, transact with them through the purchase system, and choose from a variety of content options. System may include synchronization mechanisms to ensure content delivery and synchronization across multiple screens or feeds. Implementations of the described techniques may include hardware, a method or process, or a computer tangible medium.

In one general aspect, method may include enabling user access to feeds from multiple content providers within an entertainment platform. Method may also include integrating feeds from multiple content providers into the system. Method may furthermore include facilitating transactions with multiple content providers through the entertainment platform's purchase system. Method may in addition include generating personalized content recommendations based on the user's viewing and purchasing history, cultural background, and emotional reactions. Method may moreover include considering the user's cultural background and emotional responses when providing content recommendations. Other embodiments of this aspect include corresponding computer systems, apparatus, and computer programs recorded on one or more computer storage devices, each configured to perform the actions of the methods.

Implementations may include one or more of the following features. Method may include capturing and storing user preferences, viewing history, and emotional responses. Method may include collecting and analyzing user behavior, preferences, viewing history, and emotional responses. Method may include generating accurate and personalized recommendations based on the collected data. Method may include selecting a subset of candidate recommendations based on normalized scores and weighted factors. Implementations of the described techniques may include hardware, a method or process, or a computer tangible medium.

In one general aspect, device may include a feed aggregation module configured to enable user access to feeds from multiple content providers within an entertainment platform. Device may also include a content provider integration component configured to integrate feeds from multiple content providers into the system. Device may furthermore include a purchase system integration component configured to facilitate transactions with multiple content providers through the entertainment platform's purchase system. Device may in addition include a personalized recommendation engine configured to generate personalized content recommendations based on the user's viewing and purchasing history, cultural background, and emotional reactions. Device may moreover include a cultural background and emotional reactions analysis component configured to consider the user's cultural background and emotional responses when providing content recommendations. Other embodiments of this aspect include corresponding computer systems, apparatus, and computer programs recorded on one or more computer storage devices, each configured to perform the actions of the methods.

Implementations may include one or more of the following features. Device may include an user profile management module configured to capture and store user preferences, viewing history, and emotional responses. Device may include a data collection and analysis module configured to collect and analyze user behavior, preferences, viewing history, and emotional responses. Device may include one or more artificial intelligence and/or machine learning (AI/ML) engines configured to generate accurate and personalized recommendations based on the collected data. Device may include a recommendation candidate selection module configured to select a subset of candidate recommendations based on normalized scores and weighted factors. Implementations of the described techniques may include hardware, a method or process, or a computer tangible medium.

In one general aspect, system may include an augmented reality integration module configured to perform an overlay of one or more virtual objects onto a visualization of the user's real-world environment. System may also include a product visualization and reservation engine. System may furthermore include an enhanced sensory integration framework. System may in addition include a personalization and sensory preference analysis module, where the system is configured to enable users to interact with an entertainment platform using AR technology and incorporate olfactory and gustatory stimuli. Other embodiments of this aspect include corresponding computer systems, apparatus, and computer programs recorded on one or more computer storage devices, each configured to perform the actions of the methods.

Implementations may include one or more of the following features. System may include an user profile management module and a recommendation candidate selection module. System may include integrating the product visualization and reservation engine with one or more selected from an electronic commerce (e-commerce) platform, a location-based service, and/or a database, enabling real-time product information retrieval, pricing, and/or availability, to facilitate a transaction through the AR interface. System may include an olfactory and gustatory stimulation module configured to incorporate olfactory and gustatory stimuli into an user's interaction, adapting sensory experiences based on one or more elements of an user profiles, preferences, and/or contextual data to provide a personalized user experience. System may include a personalization and sensory preference analysis module that utilizes advanced data analytics techniques to understand and cater to individual user preferences for sensory experiences, generating personalized scent and taste profiles, ensuring delivered sensory cues align with each user's preferences and maximize engagement. System may include augmented reality and enhanced sensory experiences, where the augmented reality experience is configured to provide one or more immersive gaming experiences, virtual product visualization in a real-world environment, and olfactory and gustatory stimuli, the augmented reality experience based on the user's preferences and/or interests. System where the augmented reality integration module employs computer vision algorithms, motion tracking, and spatial mapping techniques to accurately align virtual content with the user's physical surroundings, creating an immersive AR experience. System where the product visualization and reservation engine integrates with e-commerce APIs, location-based services, and databases, retrieving real-time product information, pricing, and availability, enabling users to interact with virtual representations of products, place orders, and make reservations directly through the AR interface. System may include an olfactory and gustatory stimulation module that delivers scent and taste experiences to users through specialized hardware and algorithms, configured to precisely emit one or more scents and or tastes that align with the virtual content and/or user interactions, enhancing one or more of immersion and/or the realism associated with an user experience. System where the olfactory and gustatory stimulation module utilizes specialized hardware and algorithms to deliver scent and taste experiences to users, synchronized with the AR environment, creating a more realistic and user experience, and enhancing immersion. Implementations of the described techniques may include hardware, a method or process, or a computer tangible medium.

In one general aspect, method may include overlaying virtual objects and information onto an user's real-world environment using AR technology. Method may also include leveraging computer vision algorithms, motion tracking, and spatial mapping techniques to accurately align virtual content with the user's physical surroundings and provide an immersive personalized user experience. Other embodiments of this aspect include corresponding computer systems, apparatus, and computer programs recorded on one or more computer storage devices, each configured to perform the actions of the methods.

Implementations may include one or more of the following features. Method may include integrating the augmented reality integration module with user profile management module and recommendation candidate selection module in an existing recommendation system, enabling real-time overlay of virtual objects onto the user's real-world environment. Method may include integrating the product visualization and reservation engine with e-commerce platforms, location-based services, and databases, enabling real-time product information retrieval, pricing, and availability, and facilitating direct purchases and reservations through the AR interface. Method may include incorporating: olfactory and gustatory stimuli into the user's interaction with the entertainment platform based on one or more user profiles, preferences, and contextual data; delivering synchronized scent and taste experiences through specialized hardware and algorithms; analyzing user profiles, historical interactions, and contextual data to generate personalized scent and taste profiles; integrating an enhanced sensory integration framework that incorporates the olfactory and gustatory stimuli into the user's interaction with the entertainment platform, adapting sensory experiences based on the user profiles, preferences, and contextual data, thereby providing a personalized user experience. Method may include integrating an olfactory and gustatory stimulation module that delivers scent and taste experiences to users through specialized hardware and algorithms, precisely emitting scents and creating taste sensations that align with the virtual content and user interactions, enhancing immersion and creating a realistic and user experience. Implementations of the described techniques may include hardware, a method or process, or a computer tangible medium.

In one general aspect, device may include an augmented reality integration module configured to overlay virtual objects and information onto an user's real-world environment using AR technology. Device may also include computer vision algorithms, motion tracking, and spatial mapping techniques to accurately align virtual content with the user's physical surroundings. Device may furthermore include an enhanced sensory integration framework incorporating olfactory and gustatory stimuli into the user's interaction with the entertainment platform based on user profiles, preferences, and contextual data. Device may in addition include an olfactory and gustatory stimulation module delivering synchronized scent and taste experiences through specialized hardware and algorithms. Device may moreover include a personalization and sensory preference analysis module analyzing user profiles, historical interactions, and contextual data to generate personalized scent and taste profiles and provide a personalized user experience. Other embodiments of this aspect include corresponding computer systems, apparatus, and computer programs recorded on one or more computer storage devices, each configured to perform the actions of the methods.

Implementations may include one or more of the following features. Device may include an integration with an existing recommendation system, where the augmented reality integration module is integrated with user profile management module and recommendation candidate selection module, enabling real-time overlay of virtual objects onto the user's real-world environment. Device may include an integration with e-commerce platforms, location-based services, and databases, enabling real-time product information retrieval, pricing, and availability, and facilitating direct purchases and reservations through the AR interface. Device may include an enhanced sensory integration framework that incorporates olfactory and gustatory stimuli into the user's interaction with the entertainment platform, adapting sensory experiences based on user profiles, preferences, and contextual data, to provide a personalized user experience. Device where the olfactory and gustatory stimulation module delivers scent and taste experiences to users through specialized hardware and algorithms, precisely emitting scents and creating taste sensations that align with the virtual content and user interactions, enhancing immersion and creating a realistic user experience. Implementations of the described techniques may include hardware, a method or process, or a computer tangible medium.

While the present invention has been described in connection with the preferred embodiments, it is to be understood that modifications and variations may be made without departing from the scope and spirit of the invention as defined by the appended claims. The detailed description and drawings included herein illustrate the embodiments of the invention and should not be considered as limiting the scope of the claims.

What is claimed is:

1. A system for performing personalization to enhance a user's experience, comprising:
a feed aggregation module configured to enable user access to feeds from multiple content providers within an entertainment platform;
a content provider integration component configured to integrate feeds from multiple content providers into the system;
a purchase system integration component configured to facilitate transactions with multiple content providers through the entertainment platform's purchase system;
a personalized recommendation engine configured to generate personalized content recommendations based on the user's viewing and purchasing history, cultural background, and emotional reactions; and
a cultural background and emotional reactions analysis component configured to consider the user's cultural background and emotional responses when providing content recommendations.

2. The system of claim 1, further comprising a user profile management module configured to capture and store user preferences, viewing history, and emotional responses.

3. The system of claim 1, further comprising a data collection and analysis module configured to collect and analyze user behavior, preferences, viewing history, and emotional responses.

4. The system of claim 1, further comprising one or more artificial intelligence and/or machine learning (AI/ML) engines configured to generate accurate and personalized recommendations based on the collected data.

5. The system of claim 1, further comprising a recommendation candidate selection module configured to select a subset of candidate recommendations based on normalized scores and weighted factors.

6. The system of claim 1, further comprising a personalization and tailoring module configured to customize the recommendations based on the user's profile, preferences, and real-time interactions.

7. The system of claim 1, further comprising a continuous feedback loop to incorporate user feedback and evolving user preferences into the recommendation system.

8. The system of claim 1, further comprising a scalable architecture and cloud deployment to ensure system performance and accommodate increasing user demands.

9. The system of claim 1, further comprising an interface for users to access feeds from multiple content providers, transact with them through the purchase system, and choose from a variety of content options.

10. The system of claim 1, further comprising synchronization mechanisms to ensure content delivery and synchronization across multiple screens or feeds.

11. A method for performing personalization to enhance a user's experience, comprising:
enabling user access to feeds from multiple content providers within an entertainment platform;
integrating feeds from multiple content providers into the system;
facilitating transactions with multiple content providers through the entertainment platform's purchase system;
generating personalized content recommendations based on the user's viewing and purchasing history, cultural background, and emotional reactions; and
considering the user's cultural background and emotional responses when providing content recommendations.

12. The method of claim 11, further comprising capturing and storing user preferences, viewing history, and emotional responses.

13. The method of claim 11, further comprising collecting and analyzing user behavior, preferences, viewing history, and emotional responses.

14. The method of claim 11, further comprising generating accurate and personalized recommendations based on the collected data.

15. The method of claim 11, further comprising selecting a subset of candidate recommendations based on normalized scores and weighted factors.

16. A device for performing personalization to enhance a user's experience, comprising:
a feed aggregation module configured to enable user access to feeds from multiple content providers within an entertainment platform;
a content provider integration component configured to integrate feeds from multiple content providers into the system;
a purchase system integration component configured to facilitate transactions with multiple content providers through the entertainment platform's purchase system;
a personalized recommendation engine configured to generate personalized content recommendations based on the user's viewing and purchasing history, cultural background, and emotional reactions; and
a cultural background and emotional reactions analysis component configured to consider the user's cultural background and emotional responses when providing content recommendations.

17. The device of claim 16, further comprising a user profile management module configured to capture and store user preferences, viewing history, and emotional responses.

18. The device of claim 16, further comprising a data collection and analysis module configured to collect and analyze user behavior, preferences, viewing history, and emotional responses.

19. The device of claim 16, further comprising one or more artificial intelligence and/or machine learning (AI/ML) engines configured to generate accurate and personalized recommendations based on the collected data.

20. The device of claim 16, further comprising a recommendation candidate selection module configured to select a subset of candidate recommendations based on normalized scores and weighted factors.
